(19) United States
(12) Patent Application Publication
(10) Pub. No.: US 2024/0192376 A1
(43) Pub. Date: Jun. 13, 2024

(54) Scanning Laser Devices and Methods with Multiple Range Emission Control Pulse Sets

(71) Applicant: Microvision, Inc., Redmond, WA (US)

(72) Inventors: Jonathan Cross, Monroe, WA (US); James Dean, Redmond, WA (US); Alga Lloyd Nothern, III, Seattle, WA (US)

(73) Assignee: Microvision, Inc., Redmond, WA (US)

(21) Appl. No.: 18/063,429

(22) Filed: Dec. 8, 2022

(51) Int. Cl. G01S 17/931; G01S 7/4861; G01S 17/08

(52) U.S. Cl. CPC G01S 17/931; G01S 7/4861; G01S 17/08

(57) ABSTRACT

The embodiments described herein provide systems and methods that can improve performance in scanning laser devices. Specifically, the systems and methods emit first emission control pulse sets that are used to detect when objects (e.g., persons) are within a relatively close first safety range. Then second emission control pulses to detect when objects are within a second safety range. Then, higher energy long-range pulse sets are conditionally emitted only when objects were not detected within the first and second safety ranges with the first and second emission control pulse sets. The use of first and second emission control pulse sets can provide for improved reliability of nearby object detections, while still meeting the energy limits needed for eye safety.

### FIELD

The present disclosure generally relates to scanning laser devices and methods, and more particularly relates to light detection and ranging (LiDAR) systems and methods.

### BACKGROUND

Scanning laser devices have been developed and implemented for a wide variety of applications, including object detection. For example, light detection and ranging (LiDAR) systems have been developed to generate 3D maps of surfaces, where the 3D maps describe the variations in depth over the surface. Such object detection and depth mapping have been used in a variety of applications, including object and motion sensing, navigation and control. For example, such LiDAR devices are being used in the navigation and control of autonomous vehicles, including autonomous devices used for transportation and manufacturing.

One issue in some LiDAR systems is the need to achieve specific effective ranges while also providing eye safety. To help achieve this, International Standard IEC 60825.1 describes example laser safety classes. Although many different laser safety classes exist, one major distinction between classes is whether a product is considered “eye-safe” or “non-eye-safe.” Eye-safe laser systems are generally considered to be incapable of producing damaging accessible radiation levels during operation, and are also generally exempt from device marking requirements, control measures, or other additional safety measures. IEC 60825.1 classifies eye-safe products as Class 1. However, products that include higher power laser devices that would otherwise be classified as non-eye-safe, may nevertheless be classified as eye-safe if the product includes additional safety measures that reduces the accessible emissions.

Thus, there remains a continuing need for systems and methods that can provide effective sensing at relatively long ranges while also providing improved eye-safety.

### BRIEF DESCRIPTION OF THE DRAWINGS

FIG. 1 shows a schematic diagram of a scanning laser device in accordance with various embodiments;

FIG. 2A shows a schematic diagram of a scanning laser device and scan field in accordance with various embodiments;

FIGS. 2B and 2C show diagrams of exemplary laser light pulses in accordance with various embodiments;

FIGS. 3A and 3B show flow diagrams of exemplary methods in accordance with various embodiments;

FIGS. 4A, 4B, 4C, 4D, 4E, 4F and 4G show graphs of exemplary pulse set energies over time in accordance with various embodiments;

FIG. 5A. shows a schematic view of an optical assembly in accordance with various embodiments of the present invention;

FIGS. 5B, 5C and 5D show graphs of optical expansion, scan trajectory, and laser light pulse set energy level adjustment in accordance with various embodiments;

FIGS. 5E and 5F show schematic views of a scanning laser device with different effective ranges and laser light pulse set energy level adjustment in accordance with various embodiments;

FIG. 5G shows a schematic view of a scanning laser device with multiple effective ranges in accordance with various embodiments;

FIGS. 6A and 6B show top and side views of a moving platform that includes a LiDAR system and resulting scan fields in accordance with various embodiments;

FIGS. 7A and 7B show side and top views of a scanning laser device in accordance with various embodiments;

FIG. 8 shows a schematic view of a LiDAR system in accordance with various embodiments;

FIG. 9 shows a schematic view of a LiDAR system in accordance with various embodiments;

FIGS. 10A and 10B show a side view and a top view of a transmit module in accordance with various embodiments;

FIGS. 11A and 11B show a side view and a top view of a receive module in accordance with various embodiments; and

FIG. 12 shows a perspective view of an integrated photonics module in accordance with various embodiments of the present invention.

### DESCRIPTION OF EMBODIMENTS

The embodiments described herein provide systems and methods that can facilitate improved eye safety while providing effective object detection in light detection and ranging (LiDAR) systems and other scanning laser devices. Specifically, the systems and methods utilize emission control systems and methods to emit emission control pulse sets that are used to detect when objects (e.g., persons) are within relatively close safety ranges. Then, a higher energy long-range pulse set is conditionally emitted only when objects were not detected within the safety ranges with the emission control pulse sets. Thus, the use of emission control pulse sets provides the ability to prevent the emission of relatively higher energy long-range pulse sets when people or other objects are within the safety range, and can thus provide improved eye safety.

And in accordance with the embodiments described herein, multiple emission control pulse sets at different energy levels are emitted for multiple safety ranges. The use of multiple emission control pulse sets for multiple safety ranges can increase the safety of laser scanning device by further ensuring that high-energy laser pulse sets for ranging are not emitted when an object is relatively close to the device. Stated another way, the use of multiple emission control pulse sets with multiple energy levels can provide for improved reliability of nearby object detection, while still meeting the energy limits needed for eye safety.

For example, in one embodiment a first emission control pulse set is first emitted to detect any objects in a first safety range. Then, responsive to an object not being detected in the first safety range, a second emission control pulse set is emitted to detect objects in a second safety range. Notably, the second emission control pulse set is emitted to detect objects in a second safety range that partially overlaps with and extends further than the first safety range. Then, responsive to an object not being detected in either the first safety range or the second safety range, a higher energy ranging pulse set is emitted. Stated another way, the higher energy ranging pulse set is conditionally emitted only when objects are not detected within either the first or second safety range with the preceding emission control pulse sets.

In accordance with the embodiments described herein, the first emission control pulse set has an energy level that is eye safe over the first safety range and is used to detect objects over the first safety range. Likewise, the second emission control pulse set has an energy level that is eye safe over the second safety range and is used to detect objects over the second safety range, where the second safety range partially overlaps with and extends further than the first safety range. Then, the higher energy ranging pulse set, which has an energy level that is eye safe over the rest of the devices ranging area, is conditionally emitted only when objects are not detected within either the first or second safety range.

Notably, this use of multiple emission control pulses with partially overlapping safety ranges can improve the reliability of detection while maintaining eye safety. Specifically, by emitting multiple emission control pulse sets with partially overlapping eye-safe ranges the reliability of detecting objects, including people, before the emission of high energy ranging pulses is increased. Thus, the use of multiple emission control pulse sets provides the ability to prevent the emission of relatively higher energy long-range pulse sets when people or other objects are within the safety ranges, and can thus provide improved eye safety.

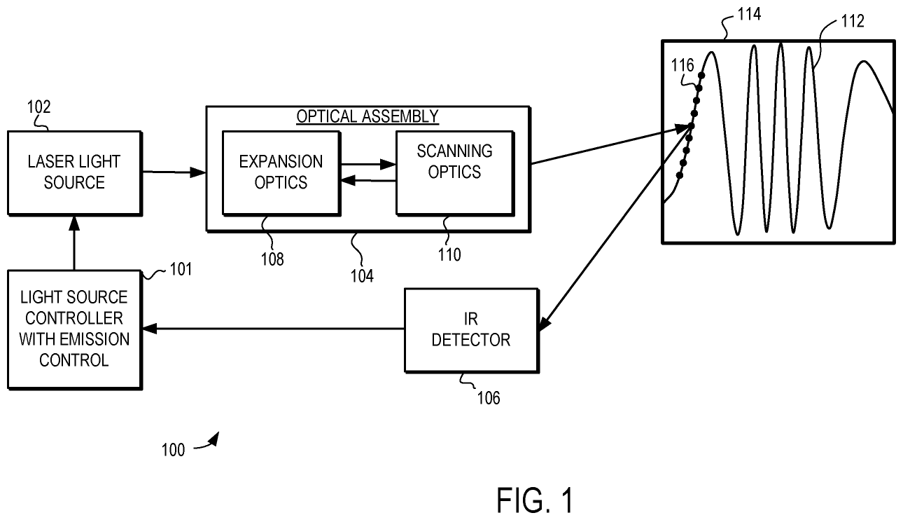

Turning now to FIG. 1, a schematic diagram of a scanning laser device 100 in accordance various embodiments is illustrated. In one embodiment, the scanning laser device 100 is a light detection and ranging (LiDAR) system used for object detection and/or 3D map generation. The scanning laser device 100 includes a light source controller 101, a laser light source 102, an optical assembly 104, and a detector 106. The optical assembly 104 includes a variety of optical elements for laser scanning, including expansion optics 108 and scanning optics 110. During operation, the laser light source 102 generates pulses of laser light that are scanned by the optical assembly 104 along a scan trajectory 112 inside a scan field 114.

These pulses of laser light impact objects in the scan field 114 in a series of scan locations or measurement points 116 along the scan trajectory 112. Notably, each “scan location” or “measurement point 116” is not an infinitely small point in space, but rather a small and finite continuous section of the scan trajectory 112. Specifically, the laser light beam traverses a finite section of the scan trajectory 112 during the round-trip transit times of the laser light pulses. Furthermore, each scan location or measurement point 116 area is also a function of laser spot size (initial size and divergence) at the distance where it encounters an object. Finally, each scan location or measurement point 116 area is also a function time between pulse sets, as the impact areas of a first emission control pulse set, a following second emission control pulse set, and a following ranging pulse set can all be part of the same scan location or measurement point 116.

The detector 106 is configured to receive reflections of the laser light pulses from the scan locations or measurement points 116 on objects within the scan field 114. The received reflections of the laser light pulses can be used to detect the objects within the scan field 114. For example, time-of-flight (TOF) measurements of the received reflections can be used to generate measurement distances. As one example, these measurement distances can be used to generate 3-dimensional point clouds that describe the depth or distance at each point, and thus can be used to generate a depth map of any detected objects.

In the example of FIG. 1, the scan trajectory 112 in the scan field 114 comprises a raster pattern. However, this is just one example, and in other embodiments other trajectories or patterns of scan lines can be generated as used. To facilitate the generation of the scan trajectory 112, a drive circuit can be implemented to controls the movement of scanning optics 110 while the expansion optics provide any desired optical expansion, including exit pointing angle expansion, beam width expansion, and bean divergence. Detailed examples of such devices will be described in greater detail below.

In addition to the detector 106 in some embodiments the scanning laser device 100 is implemented to include one or more additional detectors. For example, a second detector can be implemented to receive reflections of the IR laser light pulses from within the scan field through the optical assembly 104.

The scanning laser device 100 can also include other elements. For example, the scanning laser device 100 can also include time-of-flight (TOF) circuitry responsive to the detector 106 to measure distances to objects at the depth measurement points 116 in the scan field.

In accordance with the embodiments described herein, the scanning laser device 100 includes emission control to provide improved eye-safety by emitting higher energy pulse sets only when objects are not detected within defined safety ranges. In general, this improved eye-safety is provided by an emission control system (e.g., the light source controller 101 with emission control, an emission control circuit and pulse generation circuit that includes or works with such a light source controller, or a virtual protective housing circuit) that causes the laser light source 102 to selectively emits laser light pulse sets at different energy levels in response to object detections.

Specifically, the light source controller 101 with emission control causes the laser light source 102 to selectively emit relatively low energy emission control pulse sets that are used to detect when objects (e.g., persons) are within relatively close safety ranges for each measurement point in the scan field. Specifically, a first emission control pulse set is first emitted to detect any objects in a first safety range. Then, responsive to an object not being detected in the first safety range, a second emission control pulse set is emitted to detect objects in a second safety range. Notably, the second emission control pulse set is emitted to detect objects in a second safety range that partially overlaps with and extends further than the first safety range. Then, responsive to an object not being detected in either the first safety range or the second safety range, a higher energy ranging pulse set is emitted. Stated another way, the higher energy ranging pulse set is conditionally emitted only when objects are not detected within either the first or second safety range with the preceding emission control pulse sets.

In accordance with the embodiments described herein, the first emission control pulse set has an energy level that is eye safe over all accessible ranges and is used to detect objects over the first safety range. Likewise, the second emission control pulse set has an energy level that is eye safe over the second safety range and is used to detect objects over the second safety range, where the second safety range partially overlaps with and extends further than the first safety range. Then, the higher energy ranging pulse set is conditionally emitted only when objects are not detected within either the first or second safety range.

It should be noted that in some embodiments additional safety ranges and additional emission control pulse sets can be implemented. In such embodiments a plurality of emission control sets would be used to determine if objects are in a plurality of safety ranges, where each additional safety range in the plurality of safety ranges extends further than the previous safety range. In such an embodiment each emission control pulse set would be generated to have an energy level that is eye safe in a corresponding safety range, and cach additional safety range can partially overlap the previous safety range. Such techniques can be extended to include as many additional emission control pulse sets and corresponding additional safety ranges as are desirable for a particular application.

As specific examples, third emission control pulse set(s) can be used to determine if an object is in a third safety range, where the third safety range extends further than the second safety range. In such an embodiment the third emission control pulse set(s) would be generated to have an energy level that is eye safe in the third safety range, and the third safety range can partially overlap the second safety range. Likewise, a fourth emission control pulse set can be used to determine if an object is in a fourth safety range, where the fourth emission control pulse set would be generated to have an energy level that is eye safe in the fourth safety range.

In some applications it may be desirable to implement the scanning laser device 100 to selectively emit multiple emission control pulse sets at the different safety ranges before emitting a long-ranging pulse set for a measurement point. For example, in some embodiments the emission of multiple first emission control pulse sets and/or multiple second emission control pulse sets without a resulting object detection in the safety range can be required before ranging pulse set(s) are emitted. Specifically, two clear first emission control pulse sets can be required in situations where an immediately previous first emission control pulse set has detected an object in the first safety range. Likewise, two clear second emission control pulse sets can be required in situations where an immediately previous second emission control pulse set has detected an object in the second safety range. Examples of such embodiments will be discussed below.

Furthermore, in some applications it may also be desirable to implement the emission control pulse sets with variable timing (e.g., variable time periods or delays between emission control pulse sets) and/or variable energy (e.g., further reduced energy levels). Specifically, the first and second emission control pulse sets can be emitted with variable timing and/or variable energy that is determined at least in part on whether previous emission control pulse sets detected an object with the safety range. The use of emission control pulse sets with variable timing and/or variable energy can provide for improved reliability of object detection in a safety range while still meeting the energy limits needed for eye safety. Examples of such embodiments will be discussed below.

To facilitate such emission control techniques the light source controller 101 can use a variety of devices and methods to vary the energy level of the laser light pulse sets. For example, the light source controller 101 can be implemented to dynamically change the pulse duration of the individual laser light pulses in the pulse set to change the energy of the pulse set. As another example, the light source controller 101 can be implemented to dynamically change the pulse amplitude of the individual laser light pulses to change the pulse set energy. As another example, the light source controller 101 can be implemented to dynamically change the current used to drive the lasers to change the energy of individual laser light pulses in the pulse set. As another example, the light source controller 101 can be implemented to dynamically change the number of lasers used to generate the individual pulses in the pulse set. As another example, the light source controller 101 can be implemented to dynamically change the number of individual pulses in each pulse set to change the energy of the resulting pulse set. And various combinations of these techniques can be employed.

In some embodiments the light source controller 101 emission control can be implemented as part of a pulse generation circuit and/or emission control circuit. In those embodiments the pulse generation circuit and/or emission control circuit functions as a light source controller to cause a laser light source to selectively emit relatively low energy emission control pulse sets that are used to detect when objects (e.g., persons) are within a relatively close safety range. Then, higher energy long-range pulse sets are conditionally emitted only when objects are not detected within the safety range, thus improving eye-safety. Detailed examples of such pulse generation circuits and emission control circuits will be described in greater detail below.

In this application, the term “pulse set” is defined as a group of one or more laser pulses that are emitted together over a relatively short time period where the received reflections are used together to provide for object detection and/or ranging. In this definition a single pulse typically corresponds to the individual burst of laser light emitted during one on/off cycle of a laser light source.

A pulse set that comprises one or more pulses can produce reflections that are used together for object detection and ranging in a variety of different ways. For example, multiple pulses in one pulse set can be implemented to provide multiple independent opportunities for objection detection. In other embodiments the results of the multiple pulses can be combined (e.g., averaged, integrated) to provide increased probability of detection and/or increased accuracy.

As another example, a pulse set with multiple pulses can be modulated using any of a variety of different techniques, including amplitude modulation, frequency modulation, phase modulation, or the like. In these examples the pulse set can be modulated to include signatures that may increase detection reliability and/or effective range of the pulse set.

As one detailed example, ranging pulse sets can be modulated to include one of a plurality of different possible signatures by varying the relative timing of the individual pulses. In some implementations a ranging pulse set that comprises multiple pulses can be modulated with a channel signature, and then received reflections can be used for ranging only when the received reflections are modulated with the same channel signature. Otherwise, received light at the detector can be rejected. In such embodiments, the modulation of multiple pulses can thus be used to reject noise and improve the signal-to-noise ratio (SNR). This can increase the effective range of the ranging pulse set without requiring additional energy in each of the individual pulses. Similarly, multiple pulses can be used in one emission control pulse set to reject noise and improve the range and/or reliability of emission control pulse set. Examples of such modulation techniques can be found in U.S. Pat. No. 11,402,476 entitled “Method and Apparatus for LIDAR Channel Encoding”.

In one embodiment, the light source controller 101 can be implemented with emission control to: emit a first emission control pulse set at a reduced first energy level to detect objects within a first safety range; responsive to not detecting an object within the first safety range with reflections of the first emission control pulse set, emit a second emission control pulse set following the first emission control pulse set and at a reduced second energy level to detect objects within a second safety range, where the second safety range extends further than the first safety range, and where the reduced second energy level is greater than the reduced first energy level; and responsive to not detecting an object within the first safety range with reflections of the first emission control pulse set and to not detecting an object within the second safety range with reflections of the second emission control pulse set, emit a ranging pulse set at a higher energy level where the higher energy level is greater than the reduced first energy level and the reduced second energy level.

In another one embodiment, the light source controller 101 can be implemented to for each measurement point in a plurality of the measurement points: emit a first emission control pulse set at a reduced first energy level to detect objects within a first safety range; responsive to not detecting an object within the first safety range with reflections of the first emission control pulse set, emit a second emission control pulse set following the first emission control pulse set and at a reduced second energy level to detect objects within a second safety range, where the second safety range extends further than the first safety range, and where the reduced second energy level is greater than first energy level, otherwise proceeding to a next measurement point in the plurality of measurement points in the scan field; responsive to not detecting an object within the first safety range with reflections of the first emission control pulse set and to not detecting an object within the second safety range with reflections of the second emission control pulse set, emit a ranging pulse set at a higher energy level where the higher energy level is greater than the reduced first energy level and the reduced second energy level, then proceeding to the next measurement point in the plurality of measurement points in the scan field; and responsive to detecting an object within the first safety range with reflections of the first emission control pulse set, emit at least two additional first emission control pulse sets for a next two measurement points in the plurality of measurement points before emitting a next second emission control pulse set, each of the at least two additional first emission control pulse sets at the reduced first energy level to detect objects within the first safety range.

In another embodiment, a method can comprise, for each measurement point in a plurality of measurement points in a scan field: emitting a first emission control pulse set at a reduced first energy level to detect objects within a first safety range; responsive to not detecting an object within the first safety range with reflections of the first emission control pulse set, emitting a second emission control pulse set following the first emission control pulse set and at a reduced second energy level to detect objects within a second safety range, where the second safety range is greater than the first safety range, and where the reduced second energy level is greater than first energy level, otherwise proceeding to a next measurement point in the plurality of measurement points in the scan field; and responsive to not detecting an object within the first safety range with reflections of the first emission control pulse set and to not detecting an object within the second safety range with reflections of the second emission control pulse set, emitting a ranging pulse set at a higher energy level where the higher energy level is greater than the reduced first energy level and the reduced second energy level, then proceeding to the next measurement point in the plurality of measurement points in the scan field.

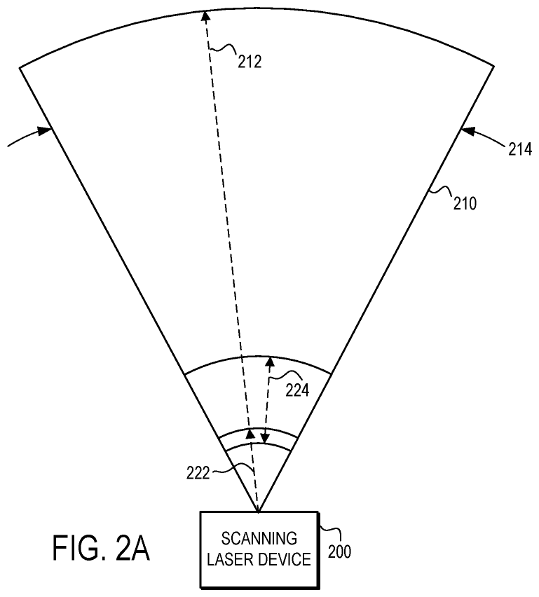

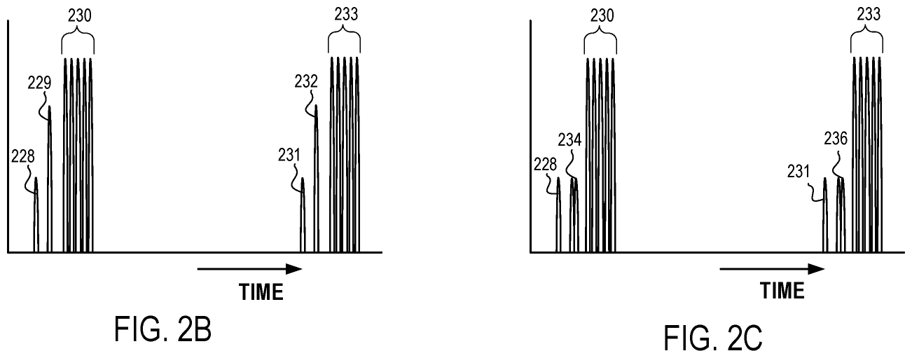

Turning now to FIG. 2A, a schematic diagram of a scanning laser device 200 is illustrated. In one embodiment, the scanning laser device 200 is a LiDAR system used for object detection and/or 3D map generation. As shown in FIG. 2A, the scanning laser device is implemented to scan for objects at multiple measurement points within in a scan field 210. In this illustrated embodiment the scan field 210 is defined in part by an effective range 212 and the output scanning angle 214. Other factors can also define the scan field 210, including the orthogonal scanning angle (not shown in FIG. 2A) and the optics of the scanning laser device 200 (e.g., laser pulse power variations, expansion optics 108, scanning optics 110) It should be noted that this is a simplified example, and that more complex implementations of scan fields are possible and will be discussed below.

As was described above, the scanning laser device 100 includes emission control to provide improved eye-safety by emitting higher energy long-range pulse sets (e.g., to the effective range 212) only when objects are not detected within a relatively close safety ranges (e.g., first safety range 222 and second safety range 224) for those measurement points. In general, to provide eye safety the first safety range 222 and second safety range 224 are implemented such that the higher energy long-range pulse sets are considered eye safe at or before the outer edge of the second safety range 224 and beyond. Again, it should be noted that safety ranges 222 and 224 are simplified examples, and more complex embodiments are possible.

During operation the emission control system causes the laser light source to selectively emit relatively low energy first emission control pulse sets that are used to detect when objects (e.g., persons) are within the relatively close first safety range 222. Then, low energy second emission control pulse sets are conditionally emitted only when objects were not detected within the first safety range. These second emission control pulse sets are conditionally emitted to detect when objects (e.g., persons) are within the intermediate second safety range 224. Finally, higher energy long-range pulse sets (with an effective range 212) are conditionally emitted only when objects were not detected within either the first safety range 222 or the second safety range 224, thus improving eye-safety. Thus, the emission control pulse sets provide the ability to selectively delay or prevent the emission of relatively higher energy long-range pulse sets when people or other objects are within the safety ranges 222 and 224 and can thus provide improved eye safety.

Notably, in this illustrated example, the second safety range 224 partially overlaps and extends further than the first safety range 222. Thus, in this example, the first emission control pulse set would be implemented to have an energy level that is eye safe over all accessible ranges (including first safety range 222) and is used to detect objects over the first safety range 222. Likewise, the second emission control pulse set would be implemented to have an energy level that is eye safe over the second safety range 224 and is used to detect objects over the second safety range, where the second safety range 224 partially overlaps with and extends further than the first safety range 222. Then, the higher energy ranging pulse set used to detect objects to the effective range 212 is conditionally emitted only when objects are not detected within either the first safety range 222 or second safety range 224 for that measurement point. This higher energy ranging pulse set would be implemented to have an energy level that is eye safe over an outer edge portion of the second safety range 224 and beyond to the effective range 212.

For example, in some regulatory environments if an emission control pulse set meets class 1 level accessible emissions limits under IEC 60825.1 over the first safety range 222 it can be expected to be eye safe over the first safety range. Likewise, if an emission control pulse set meets class 1 level accessible emissions limits under IEC 60825.1 over second safety range 224, including the portion overlapping the first safety range 222, it can be expected to be eye safe over that second safety range.

As specific examples, the first emission control pulse sets can be implemented with energy levels to provide reliable object detection out to at least 5 m while also meeting class 1 level accessible emissions limits under IEC 60825.1 over a first safety range 222 of 100 mm to 5 m. Likewise, the second emission control pulse sets can be implemented with energy levels to provide reliable object detection out to at least 10 m while also meeting to meet class 1 level accessible emissions limits under IEC 60825.1 over a second safety range 224 of 4 m to 10 m while providing reliable object detection out to 10 m. Thus, both the first emission control pulse sets and the second emission control pulse sets meet the class 1 level accessible emissions limits under IEC 60825.1 between 4 m and 5 m and provide reliable object detection over that overlapping range.

As further detailed examples, in extremely bright sunlight, a first emission control pulse set that is eye-safe at 100 mm may have a very low 10-10 probability of not detecting an object with a 20% reflectivity at a first safety range distance of 5 m. Likewise, in extremely bright sunlight, a second emission control pulse set that is eye-safe at 4 m may also have a very low 10-10 probability of not detecting an object with a 20% reflectivity at second safety range distance of 10 m.

Turning now to FIG. 2B, an exemplary string of laser pulses that together constitute emission control pulse sets and ranging pulse sets in accordance with various embodiments of the present invention is illustrated. Specifically, FIG. 2B shows pulses 228, 229, 231, 232 that constitute an exemplary emission control pulse sets and shows pulses 230, 233 that constitute exemplary ranging pulse sets. As was described above, the term “pulse set” is defined as a group of one or more laser pulses that are emitted together over a relatively short time period where the received reflections are used together to provide for object detection and/or ranging.

In this example, a first emission control pulse set (composed of pulse 228) is emitted before a second emission control pulse set (composed of pulse 229), both of which are emitted before a ranging pulse set (composed of pulses 230). Likewise, a next first emission control pulse set (composed of pulse 231) is emitted before a next second emission control pulse set (composed of pulse 232), both of which are emitted before a next ranging pulse set (composed of pulses 233).

In such an embodiment, the pulse 229 for the second emission control pulse set would only be emitted when the pulse 228 for the first emission control pulse set did not result in the detection of an object within the first safety range 222. Likewise, the pulse 232 for the next second emission control pulse set would only be emitted when the pulse 231 for the next first emission control pulse set did not result in the detection of an object within the first safety range 222.

Likewise, the pulses 230 for the ranging pulse set would only be emitted when both the pulse 228 for the first emission control pulse set and the pulse 229 for second emission control pulse set did not result in the detection of an object within the first safety range 222 and the second safety range 224. Finally, the pulses 233 for the next ranging pulse set would only be emitted when the both pulse 231 for the next first emission control pulse set and the pulse 232 for a next second emission control pulse set did not result in the detection of an object within the first safety range 222 and the second safety range 224.

In this example, each emission control pulse set comprises only one pulse 228, 229, 231, 232 while each long-range ranging pulse set comprises five pulses 230, 233 that are closely spaced in time to effectively function as one pulse set. For example, the ranging pulse set of five pulses 230 can be emitted over a time period between 30-90 ns. The pulses 228, 229, 231, and 231 are thus examples of the types of emissions that may be emitted by a LiDAR or other scanning laser device (e.g., scanning laser device 100, 200) for each measurement point or measurement point in the scan field 210.

It should be noted that pulse 228, pulse 229 and pulses 230 do not effectively constitute parts of the same pulse set, and instead provide separate detection events. However, it should also be noted that because the time between pulse 228 and the following pulses 229 and 230 are short enough such that they both are effectively scanning the same scan location or measurement point as defined in part by the emission direction of laser light pulse set. This means that pulse 228 can reliably detect if an object is within the safety range at effectively the same scan location or measurement point (e.g., measurement point 116) where the following pulses 229 and 230 will impact. As one non-limiting example, the pulse 228 can be separated in time from the pulses 230 by between 90-500 ns.

Next it should also be noted that in this example the pulses 228, 229 and 230 would correspond to a first scan location or measurement point (e.g., a first measurement point 116 in FIG. 1) and the pulses 231, 232 and 233 correspond to a next scan location or later measurement point in the scan field 210 (e.g., a next measurement point 116 in FIG. 1).

Again, the first emission control pulse sets (e.g., pulses 228, 231) are generated to have an energy level that provides a very high probability of detecting an object within a designed short safety range 222 while also providing eye-safety within that short safety range 222. Likewise, the second emission control pulse sets (e.g., pulses 231, 232) are generated to have an energy level that provides a very high probability of detecting an object within a designed intermediate safety range 224 while also providing eye-safety within that intermediate second safety range 224.

The long-range ranging pulse sets (e.g., pulses 230, 233) can then be generated to have an energy level that is eye-safe from the outer edge area of the intermediate safety range 224 and beyond, while providing reliable long-range detection to the effective range 212.

It should be noted that while FIG. 2B shows one pulse 228, 229, 231, 232 for each emission control pulse set and sets of five pulses 230, 233 being emitted for each ranging pulse set that any suitable number of pulses in each pulse set can be used. For example, instead of a set of multiple pulses 230, 233 for ranging to each scan location a single pulse that has relatively high energy level may be used. As another example, instead of one pulse 228, 229, 231, 232 for each emission control pulse set, multiple pulses of relatively lower energy can be used for each emission control pulse set. Furthermore, in some embodiments, different numbers of pulse each having the same energy level may be employed to provide multiple ranges. For example, a short range for emission control pulse sets may be provided by the energy of a single pulse, while a long range for ranging pulse sets may be provided by the energy of multiple pulses, where each of the multiple pulses have same energy as the single pulse used for the emission control pulse sets. As another example, a short range for emission control pulses may be defined by the energy of a single short-range pulse, while an intermediate range may be defined by multiple pulses, each having the same energy as the short-range pulse, and a long range may be defined by more pulses with the same or greater energy as the short-range pulses.

Turning to FIG. 2C, another exemplary string of laser pulses that constitute emission control pulse sets and ranging pulse sets in accordance with various embodiments of the present invention is illustrated. In this example, the two second emission control pulse sets comprise multiple pulses of relatively lower energy. Specifically, in this example the second emission control pulse set is composed of two pulses 234 and the next second emission control pulse set is composed of two pulses 236. Thus, the intermediate range of the second emission control pulse sets is provided and defined by multiple pulses.

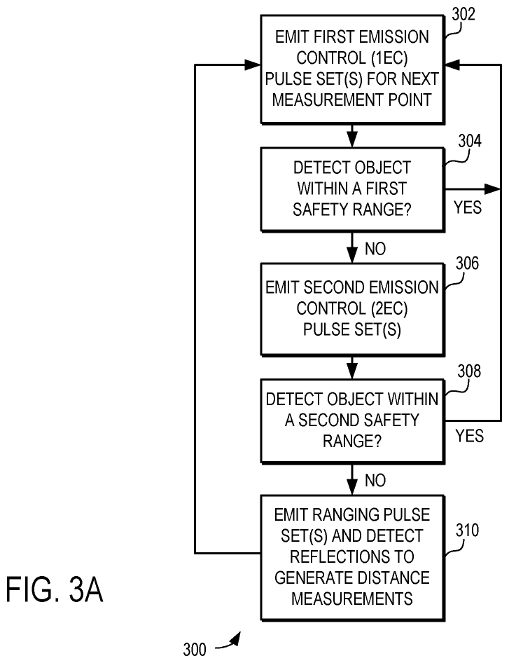

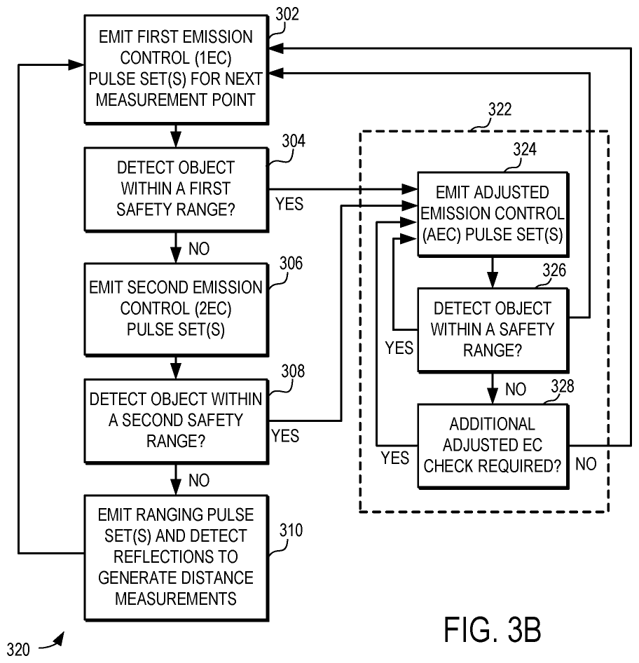

Turning now to FIG. 3A, a flow diagram illustrates a method 300 in accordance with various embodiments. In some embodiments, method 300, or portions thereof, is performed by a LiDAR or other scanning laser device (e.g., scanning laser device 100, 200). For example, method 300 can be performed by a series of circuits or an electronic system that is part of, in communication with, or otherwise associated with a scanning laser device. Method 300 is not limited by the particular type of apparatus performing the method.

At step 302 a first emission control (1EC) pulse set(s) is emitted for a next measurement point. As described above, this first emission control pulse set(s) includes one or more laser light pulses at a reduced energy level that are emitted to determine if any objects are within a relatively close safety range (e.g., safety range 222 of FIG. 2A). As such, the laser light pulse set can be implemented with an energy level that is considered eye safe over all ranges, including at least all accessible portions of the first safety range.

At step 304 it is determined if an object was detected within a first safety range with the first emission control pulse set. As was described above, in one embodiment a detector (e.g., detector 106 of FIG. 1) is configured to receive reflections of the laser light pulses from objects within the scan field. The received reflections of the laser light pulses can then be used to detect those objects and determine the distance to those objects (e.g., using time-of-flight (TOF) measurements and calculating distances from those TOF measurements). In one embodiment, step 304 can include comparing the TOF measurements to a threshold, where the value of the threshold corresponds to the desired first safety range based on a variety of suitable factors. Thus, the received reflections of the emission control pulse set can be used to determine if there is an object within a designated first safety range.

At step 306 a second emission control (2EC) pulse set(s) is emitted for the measurement point. As described above, this second emission control pulse set(s) includes one or more laser light pulses at a reduced energy level that are emitted to determine if any objects are within an intermediate safety range (e.g., second safety range 224 of FIG. 2A). As such, the laser light pulse set is implemented with an energy level that is considered eye safe within at least a portion of that second safety range, where the second safety range partially overlaps with the first safety range.

At step 308 it is determined if an object was detected within the second safety range with the second emission control pulse set. Again, the received reflections of the laser light pulses can then be used to detect those objects and determine the distance to those objects (e.g., using time-of-flight (TOF) measurements and calculating distances from those TOF measurements). In one embodiment, step 308 can include comparing the TOF measurements to a second threshold, where the value of the second threshold corresponds to the desired second safety range based on a variety of suitable factors. Thus, the received reflections of the second emission control pulse set can be used to determine if there is an object within a designated second safety range. Furthermore, in some embodiments using such a second threshold the received reflections of the second emission control pulse set can also be used to determine if there is an object closer than the second safety range (i.e., within the first safety range).

If no object is detected within the second safety range, the method 300 proceeds to step 310. At step 310 one or more ranging pulse sets are emitted and any received reflections of the ranging pulse set are used to generate distance measurements. It should also be noted that in a typical embodiment the time between the emission of the first emission control pulse set in step 302 and the emission of the following ranging pulse set in step 310 is short enough that the first emission control pulse set, the second emission control pulse set, and the ranging pulse set are effectively impacting and reflecting from the same measurement point or scan location.

The ranging pulse set emitted in step 310 provides for relatively long-range object detection and distance measurement. As such, the energy of the ranging pulse set is typically much greater than the energy level of the preceding first emission control pulse set emitted in the previous step 302. Likewise, the energy of the ranging pulse set is greater than the energy level of the preceding second emission control pulse set emitted in the previous step 306. Stated another way, a ranging pulse set is emitted at a higher energy level where the higher energy level is greater than the reduced first energy level of the first emission control pulse set and the reduced second energy level of the second emission control pulse set.

Thus, at step 310 a relatively high-energy pulse sets providing relatively long-range object detection (e.g., to the effective range 212 of FIG. 2A) are emitted only when an object was not detected within the first safety range (e.g., first safety range 222 of FIG. 2A) with the emission control pulse sets emitted in step 302 and an object was not detected within the second safety range (e.g., second safety range 224 of FIG. 2A). Thus, the method 300 provides improved eye-safety by only emitting relatively high-energy ranging pulse sets when no objects were detected for a given scan location or measurement point within the safety ranges by the preceding emission control pulse sets.

Received reflections of the ranging pulse set are used to generate distance measurements. Again, in one embodiment an IR detector is configured to receive reflections of the ranging pulse set from objects within the scan field. The received reflections of the ranging pulse set can then be used to detect those objects and determine the distance to those objects (e.g., using TOF measurements). In one embodiment multiple calculated distances are used to generate a point cloud of data (e.g., a 3D point (X, Y, Z) cloud data that may be written to a memory or other data storage device). And as described above, in some embodiments modulation techniques can be applied to the ranging pulse sets to increase the SNR and effective range.

With distance measurements generated from any received reflections in step 310, the method 300 returns to step 302 where a next first emission control (1EC) pulse set(s) is emitted for a next measurement point and the process continues.

Steps 302, 304, 306, 308 and 310 can thus be continuously repeated to generate measurement distances for different measurement points in the scan field as long as no objects are detected within the first and second safety range. However, if at any step 304 or 308 it is instead determined that an emission control pulse set resulted in the detection of an object within either safety range, the method returns to step 302 without emitting a ranging pulse set.

It should be noted that in some embodiments of method 300 that after a detection of an object in a safety range that multiple emission control pulse sets without another detection can be required before any higher energy pulse sets are emitted. Requiring multiple “clear” emission control pulse sets following a detection in the safety range can provide further increased safety. For example, in one embodiment two emission control pulse sets without further detection are required following a detection in the safety range before proceeding to pulse sets with higher energy levels. Detailed examples of such embodiments will be discussed below.

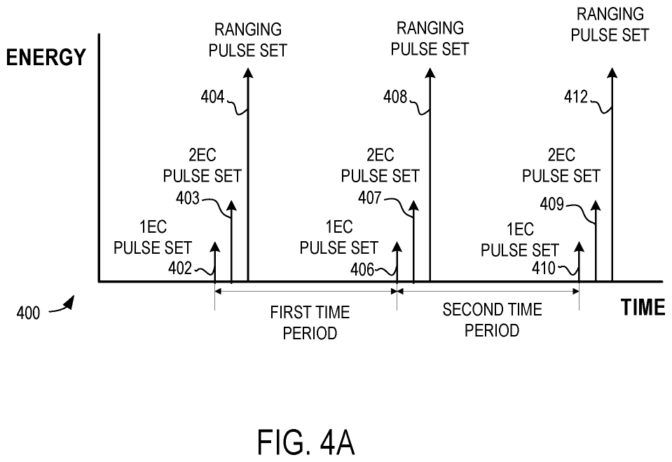

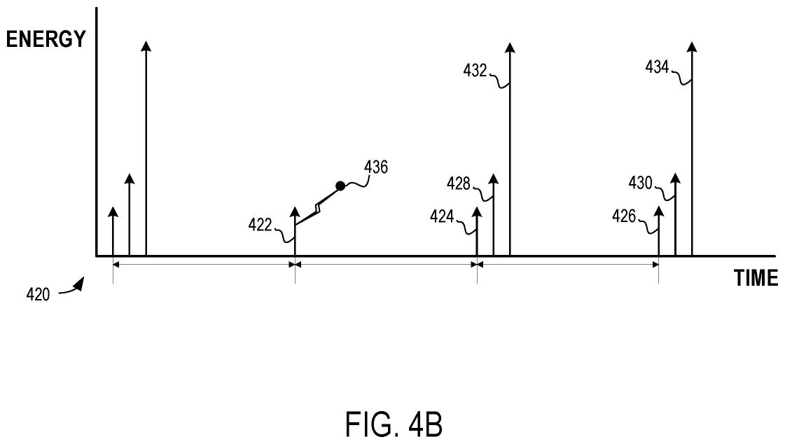

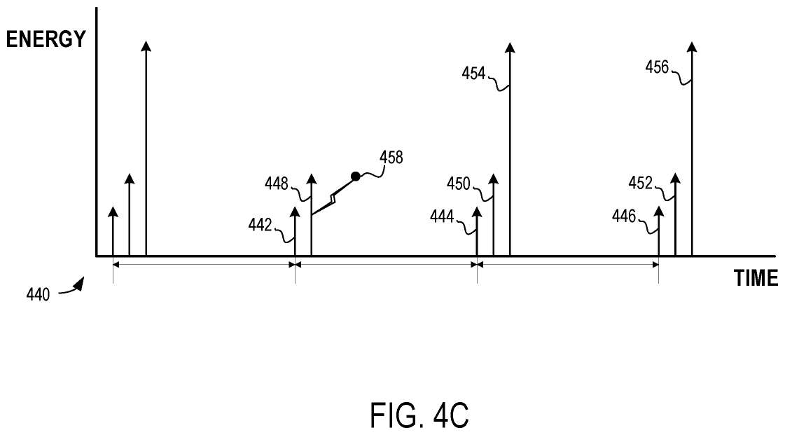

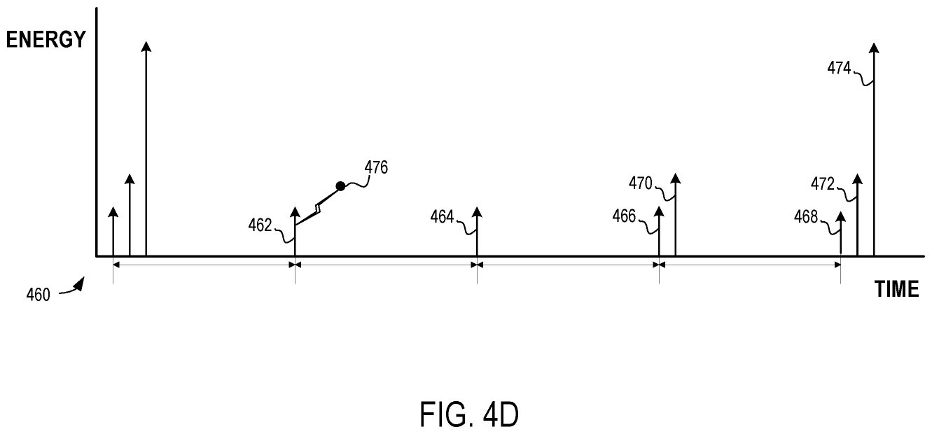

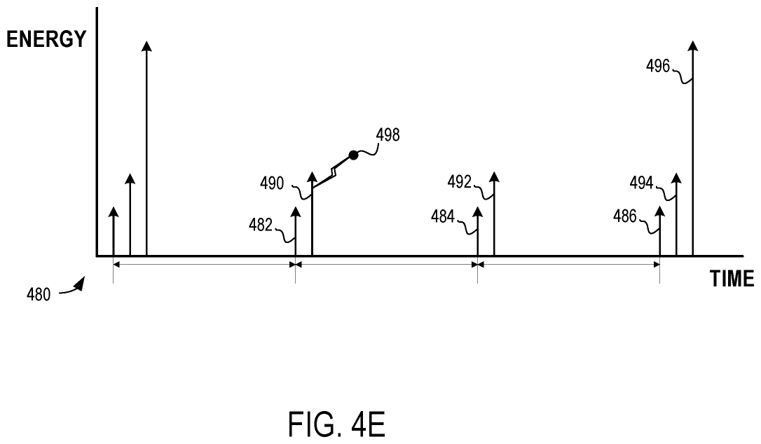

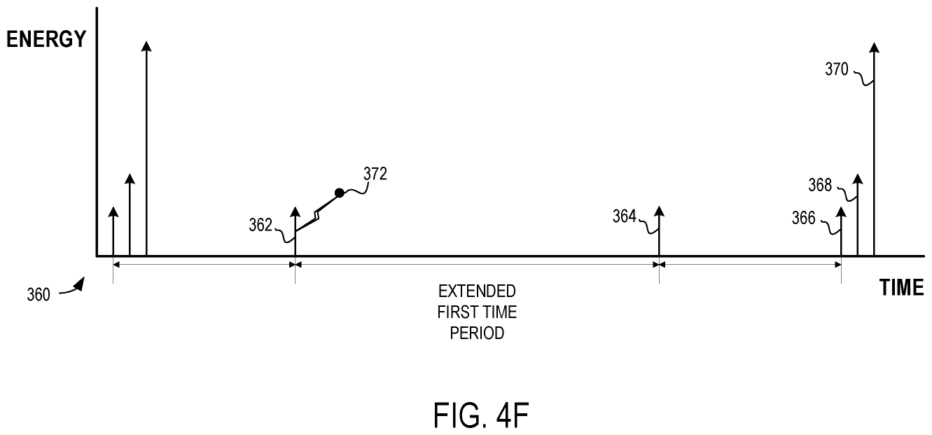

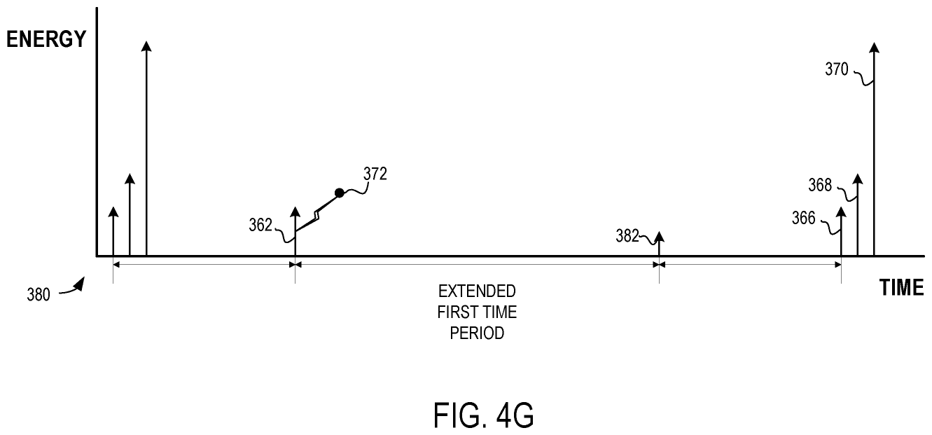

Turning now to FIG. 4A-4E, exemplary graphs of exemplary pulse set energy over time are illustrated. Specifically, the graphs illustrate the energy of various emission control pulse sets and ranging pulse sets according to exemplary operational scenarios and in accordance with the various embodiments described herein.

Turning to FIG. 4A specifically, graph 400 illustrates the relative energy and timing of emission control pulse sets and ranging pulse sets in an exemplary operational scenario when no objects are detected in either the first safety range or the second safety range. Specifically, graph 400 illustrates the energies 402, 406 and 410 of three first emission control (1EC) pulse sets, the energies 403, 407 and 409 of three second emission control (2EC) pulse sets, and the energies 404, 408 and 412 of three corresponding ranging pulse sets.

In this illustrated example, a first emission control (1EC) pulse set having energy 402 is followed by a second emission control (2EC) pulse set having energy 403 and a ranging pulse set having energy 404. Likewise, a first emission control (1EC) pulse set having energy 406 is followed by a second emission control (2EC) pulse set having energy 407 and a ranging pulse set having energy 408. Finally, a first emission control (1EC) pulse set having energy 410 is followed by a second emission control (2EC) pulse set having energy 409 and a ranging pulse set having energy 412. As will be described in greater detail below, FIG. 4A thus illustrates repeated performances of steps 302, 304, 306, 308 and 310 in method 300 as illustrated in FIG. 3A.

Again, each of the emission control pulse sets and ranging pulse sets comprise one or more pulses closely spaced in time to provide one object detection and/or ranging event. In such cases the timing of the pulse sets can be referenced by the leading edge of the first pulse, the center time of the multiple pulses, or the trailing edge of the last pulse, to give three non-limiting examples. And notably in this illustrated example the energies 402, 403, 404, 406, 407, 408, 410, 409 and 412 are the combined energies of all the pulses in the corresponding pulse set with the timing based on the beginning of the first pulse in each set.

In this example, the first emission control (1EC) pulse set having energy 402 is emitted to detect any possible objects within a first safety range (e.g., performing step 302 of method 300), and with no objects detected in the safety range (e.g., step 304), a second emission control (2EC) pulse set having energy 403 is emitted to detect any possible objects within a second safety range (e.g., performing step 306 of method 300), and with no objects detected in the second safety range (e.g., step 308) a ranging pulse set having energy 404 is emitted (e.g., step 310). It should again be noted that because the time between the first emission control pulse set and the first ranging pulse set is relatively short, the pulse sets are both emitted in substantially the same direction and are both effectively scanning the same scan location or measurement point.

Then, a first time period after the emission of the first emission control pulse set, a next first emission control (1EC) pulse set having energy 406 is emitted to detect any possible objects within the first safety range. With no objects detected in the first safety range, a next second emission control (2EC) pulse set having energy 407 is emitted to detect any possible objects within the second safety range, and with no objects detected in the first or second safety range, a next ranging pulse set having energy 408 is emitted (e.g., another performance steps 302, 304, 306, 308, 310).

Then, a second time period after the emission of the first emission control pulse set, a next first emission control (1EC) pulse set having energy 410 is emitted to detect any possible objects within the first safety range. With no objects detected in the first safety range, a next second emission control (2EC) pulse set having energy 409 is emitted to detect any possible objects within the second safety range, and with no objects detected in the first or second safety range, a next ranging pulse set having energy 412 is emitted (e.g., another performance steps 302, 304, 306, 308, 310)

It also should be noted that in this example the first emission control (1EC) pulse set, second emission control (2EC) pulse set, and first ranging pulse set would correspond to a first scan location or measurement point, and later pulse sets would correspond to a next scan location or later measurement point in the scan field, and so forth.

In general, the first emission control (1EC) pulse sets are generated to have energies 402, 406 and 410 that provide a very high probability of detecting an object within a designed close safety range while also providing eye-safety within at least a part of that safety range (e.g., eye safe 100 millimeters from the output of the scanning laser and beyond). The second emission control (2EC) pulse sets are generated to have energies 403, 476 and 409 that provide a very high probability of detecting an object within an intermediate second safety range while also providing eye-safety within that second safety range (e.g., eye safe 4 meters from the output of the scanning laser device and beyond). The ranging pulse sets are conversely generated to have energies 404, 408 and 410 that are eye-safe from near the outer edge of the second safety range and beyond (e.g., 9 meters from the output of the scanning laser device and beyond), while providing reliable long-range detection to an effective range beyond the safety range.

Specifically, the first emission control pulse (1EC) sets can be generated to have energies 402, 406 and 410 at a first reduced energy level. The second emission control (2EC) pulse set can be generated to have energies 403, 407 and 409 at a second reduced energy level, where the second reduced energy level is higher than the first reduced energy level. In each the case the reduced energy levels are less than the higher energy levels of the following ranging pulse set.

Turning now to FIG. 4B, graph 420 illustrates the energy and timing of emission control pulse sets and ranging pulse sets in an exemplary operational scenario when an object is detected in a safety range with an emission control pulse set. Specifically, graph 420 illustrates the energies 422, 424, and 426 of three first emission control (1EC) pulse sets, energies 428 and 430 of two second emission control (2EC) pulse sets and the energies 432 and 434 of a following ranging pulse set. As will be described in greater detail below, FIG. 4B illustrates another example of the pulse sets emitted during method 300 of FIG. 3A.

In this example, a first emission control (1EC) pulse set having energy 422 is emitted to detect any possible objects within a first safety range (e.g., performing step 302 of method 300). This results in the detection of an object 436 in the first safety range (e.g., step 304). Thus, no second emission control (2EC) pulse set and no ranging pulse set is emitted for the current measurement point.

Instead, a next first emission (1EC) pulse set having energy 424 is emitted for a next measurement point to again detect any possible objects within the first safety range (e.g., reperforming step 302 of method 300). This time there is no detection of an object in the first safety range (e.g., reperforming step 304).

Thus, a second emission control (2EC) pulse set having energy 428 is emitted to detect any possible objects within the second safety range (e.g., step 306). This does not result in the detection of an object in the second safety range (e.g., step 308). Thus, a ranging pulse set having energy 432 is emitted (e.g., step 310).

A next first emission (1EC) pulse set having energy 426 is emitted for a next measurement point to again detect any possible objects within the first safety range (e.g., reperforming step 302 of method 300). Again, there is no detection of an object in the first safety range (e.g., reperforming step 304).

Thus, a next second emission control (2EC) pulse set having energy 430 is emitted to detect any possible objects within the second safety range (e.g., step 306). This again does not result in the detection of an object in the second safety range (e.g., step 308). Thus, a next ranging pulse set having energy 434 is emitted (e.g., step 310).

Turning now to FIG. 4C, graph 440 illustrates the energy and timing of emission control pulse sets and ranging pulse sets in another exemplary operational scenario. In this operational scenario an object is detected in a second safety range with a second emission control (2EC) pulse set.

Specifically, in this example a first emission control (1EC) pulse set having energy 442 is emitted to detect any possible objects within a first safety range (e.g., performing step 302 of method 300). This time there is no detection of an object in the first safety range (e.g., step 304). Thus, a second emission control (2EC) pulse set having energy 448 is emitted to detect any possible objects within the second safety range (e.g., step 306).

This results in the detection of an object 458 in the second safety range (e.g., step 308). Thus, no ranging pulse set is emitted for the current measurement point.

Instead, a next first emission (1EC) pulse set having energy 424 is emitted for a next measurement point to again detect any possible objects within the first safety range (e.g., reperforming step 302 of method 300). Again, there is no detection of an object in the first safety range (e.g., reperforming step 304).

Thus, a second emission control (2EC) pulse set having energy 450 is emitted to detect any possible objects within the second safety range (e.g., step 306). This time there is no detection of an object in the second safety range (e.g., step 308). Thus, a ranging pulse set having energy 454 is emitted (e.g., step 310).

A next first emission (1EC) pulse set having energy 446 is emitted for a next measurement point to again detect any possible objects within the first safety range (e.g., reperforming step 302 of method 300). Again, there is no detection of an object in the first safety range (e.g., step 304).

Thus, a next second emission control (2EC) pulse set having energy 452 is emitted to detect any possible objects within the second safety range (e.g., step 306). This again does not result in the detection of an object in the second safety range (e.g., step 308). Thus, a next ranging pulse set having energy 456 is emitted (e.g., step 310).

As described above, in some embodiments multiple emission control pulse sets without further detection can be required following an object detection in a safety range. Requiring multiple “clear” emission control pulse sets following a detection in the safety range can further increase the safety in some embodiments.

For example, in one embodiment two emission control pulse sets without further detection are required following a detection in the safety range before proceeding to pulse sets with higher energy levels. Thus, if an object is detected in the first safety range two clear first emission control (1EC) pulse sets would be required before proceeding to second emission control (2EC) pulse sets, and two clear second emission control (2EC) pulse sets would be required before proceeding to ranging pulse sets.

Turning now to FIG. 4D, graph 460 illustrates the energy and timing of emission control pulse sets and ranging pulse sets in an exemplary operational scenario when an object is detected in a safety range with an emission control pulse set. Again, in this example two emission control pulse sets without further detection are required following a detection in the safety range before proceeding to pulse sets with higher energy levels.

Specifically, graph 460 illustrates the energies 462, 464, 466, and 468 of four first emission control (1EC) pulse sets, energies 470 and 472 of two second emission control (2EC) pulse sets and the energy 474 of a following ranging pulse set.

In this example, a first emission control (1EC) pulse set having energy 462 is emitted to detect any possible objects within a first safety range (e.g., performing step 302 of method 300). This results in the detection of an object 476 in the first safety range (e.g., step 304). Thus, no second emission control (2EC) pulse set and no ranging pulse set is emitted for the current measurement point.

Instead, a next first emission (1EC) pulse set having energy 464 is emitted for a next measurement point to again detect any possible objects within the first safety range (e.g., reperforming step 302 of method 300). This time there is no detection of an object in the first safety range (e.g., reperforming step 304). However, because two clear emission control pulse sets are required, no further pulse sets are emitted at that measurement point.

Instead, a next first emission (1EC) pulse set having energy 466 is emitted for the next measurement point to again detect any possible objects within the first safety range (e.g., reperforming step 302 of method 300). Again, there is no detection of an object in the first safety range (e.g., reperforming step 304).

With two first emission (1EC) pulse sets having been emitted without further detection, a second emission control (2EC) pulse set having energy 470 is emitted to detect any possible objects within the second safety range (e.g., step 306). This does not result in the detection of an object in the second safety range (e.g., step 308). However, because two clear emission control pulse sets are again required, no further pulse sets are emitted at that measurement point.

Instead, a next first emission (1EC) pulse set having energy 468 is emitted for the next measurement point to again detect any possible objects within the first safety range (e.g., reperforming step 302 of method 300). Again, there is no detection of an object in the first safety range (e.g., reperforming step 304). Thus, a next second emission control (2EC) pulse set having energy 472 is emitted to detect any possible objects within the second safety range (e.g., step 306). This again does not result in the detection of an object in the second safety range (e.g., step 308). Thus, a next ranging pulse set having energy 474 is emitted (e.g., step 310).

Thus, in this example two clear first emission control (1EC) pulse sets were required after detection before proceeding to second emission control (2EC) pulse sets, and two clear second emission control (2EC) pulse sets were required before proceeding to ranging pulse sets.

It should be noted that in some embodiments, two clear emission control pulse sets would be required only for safety range where the object was detected and in farther safety ranges, but not for closer safety ranges.

Turning now to FIG. 4E, graph 480 illustrates the energy and timing of emission control pulse sets and ranging pulse sets in an exemplary operational scenario when an object is detected in a safety range with an emission control pulse set. Again, in this example two emission control pulse sets without further detection are required following a detection in the safety range before proceeding to pulse sets with higher energy levels. However, in this particular case, two clear emission control pulses are not required for safety ranges that are closer than the detected object.

Specifically, graph 480 illustrates the energies 482, 484, and 486 of three first emission control (1EC) pulse sets, energies 490, 492 and 494 of three second emission control (2EC) pulse sets and the energy 496 of a following ranging pulse set.

In this example, a first emission control (1EC) pulse set having energy 482 is emitted to detect any possible objects within a first safety range (e.g., performing step 302 of method 300). This time there is no detection of an object in the first safety range (e.g., step 304). Thus, a second emission control (2EC) pulse set having energy 490 is emitted to detect any possible objects within the second safety range (e.g., step 306). This results in the detection of an object 498 in the second safety range (e.g., step 308). Thus, no ranging pulse set is emitted for the current measurement point.

Instead, a next first emission (1EC) pulse set having energy 484 is emitted for a next measurement point to again detect any possible objects within the first safety range (e.g., reperforming step 302 of method 300). Again, there is no detection of an object in the first safety range (e.g., reperforming step 304). Thus, a second emission control (2EC) pulse set having energy 492 is emitted to detect any possible objects within the second safety range (e.g., step 306). This does not result in the detection of an object in the second safety range (e.g., step 308). However, Thus, no ranging pulse set is emitted for the current measurement point. However, because two clear second emission control (2EC) pulse sets are required following detection, no further pulse sets are emitted at that measurement point.

Instead, a next first emission (1EC) pulse set having energy 486 is emitted for a next measurement point to again detect any possible objects within the first safety range (e.g., reperforming step 302 of method 300). Again, there is no detection of an object in the first safety range (e.g., reperforming step 304). Thus, a second emission control (2EC) pulse set having energy 494 is emitted to detect any possible objects within the second safety range (e.g., step 306). This again does not result in the detection of an object in the second safety range (e.g., step 308). Thus, a next ranging pulse set having energy 496 is emitted (e.g., step 310).

Thus, in this example two clear second emission control (2EC) pulse sets were required after detection before proceeding to the ranging pulse set. However, two clear first emission control (1EC) pulse sets were not required before emitting the next second emission control (2EC) pulse set, because two clear pulse sets were only required for safety range where the object was detected and in further safety ranges, but not for closer safety ranges.

In some further embodiments the various emission control pulse sets can be adjusted in response to the detection of objects in the safety regions. For example, in some embodiments these emission control pulse sets are emitted with variable timing (e.g., variable time periods or delays between emission control pulse sets) and/or variable energy (e.g., further reduced energy levels). Specifically, the emission control pulse sets are emitted with variable timing and/or variable energy that is determined at least in part on whether previous emission control pulse sets detected an object with the safety range. The use of emission control pulse sets with variable timing and/or variable energy can provide for improved reliability of object detection in a safety range, while still meeting the energy limits needed for eye safety.

Specifically, in many scanning laser device applications the total energy of pulse sets over specific time frames should be considered to provide effective eye safety. By selectively delaying with variable timing and/or further reducing the energy level of emission control pulse sets that follow the detection of an object in the safety range, the embodiments described herein facilitate an increase in the energy level of other emission control pulse sets while maintaining or improving eye safety. Specifically, selectively delaying and/or further reducing the energy level of an emission control pulse set that follows the detection of an object in the safety range allows that preceding emission control pulse sets (e.g., those before the detection of the object in the sensing region) to have been emitted with higher energy. Thus, the embodiments can provide an increase in the energy level of previous emission control pulse sets while maintaining or decreasing the potential energy exposure to the eye over time. This increased energy in the previous emission control pulse sets provides for improved reliability in detecting objects in the safety range while maintaining eye safety for both emission control pulse sets. Thus, the embodiments described herein can provide improved reliability of detection of objections in the safety range and improved eye safety.

For example, under some safety limit specifications and/or regulatory environments (e.g., regulatory classification limits under IEC 60825.1), a single emission control pulse set having an energy of 6.60E-07 joules can be considered eye-safe at 100 mm if no other pulses are emitted over a time frame of 5.00E-06 seconds around the emission control pulse set (and if the system meets a variety of other parameters, e.g., wavelength, angular subtense, beam divergence, and apparent source location). Likewise, two emission control pulse sets, each having an energy of 3.30E-07 joules can be considered eye-safe at 100 mm if no other pulses are emitted over a time frame of 5.00E-06 seconds around the two pulse sets and if the pulses themselves do not exceed any other regulatory limits. Thus, in these regulatory environments it is the total energy of all the emission control pulse sets over a defined time period that determines if emission control pulse sets are considered eye-safe at a specified distance. And in such regulatory environments selectively delaying with variable timing and/or further reducing the energy level of emission control pulse sets that follow the detection of an object in the safety range allows for an increase in the energy level of other emission control pulse sets while maintaining compliance with regulatory classification limits.

Turning now to FIG. 3B, a flow diagram illustrates a method 320 in accordance with various embodiments. Again, in some embodiments method 320, or portions thereof, is performed by a LiDAR or other scanning laser device (e.g., scanning laser device 100, 200).

In method 320 the steps 302, 304, 306, 308 and 310 are performed as described above with reference to FIG. 3A. Steps 302, 304, 306, 308 and 310 can thus be continuously repeated to generate measurement distances for different measurement points in the scan field as long as no objects are detected within the first and second safety range.

However, if at any step 304 or 308 it is instead determined that an emission control pulse set resulted in the detection of an object within either safety range, the method 320 shifts to an adjusted emission control process 322 that includes steps 324, 326 and 328. At step 324 an adjusted emission control (AEC) pulse set(s) is emitted. The adjusted emission control pulse set is again a set of laser light pulses having a reduced energy level provided to determine if any objects are within a relatively close safety range (e.g., safety ranges 222 and 224 of FIG. 2A). However, in this step 324 the adjusted emission control pulse set is modified relative to the emission control pulse set emitted that would have been emitted in the next step 302 if no object had been detected in the safety ranges in either step 304 or 308.

Specifically, the adjusted emission control pulse set includes at least one of an extended first time period following the first emission control pulse set and a further reduced second energy level relative to the reduced second energy level. Thus, the emitted adjusted emission control pulse set of step 324 is adjusted to have an extended time delay period before it is emitted and/or a further reduced energy level compared to the emission control pulse set that would have been emitted in the next step 302 if an object had not been detected within the safety ranges in step 304 or 308.

For example, in some embodiments the emitted adjusted emission control pulse set of step 324 is adjusted to have a further reduced energy level compared to the emission control pulse set that would have been emitted in the next step 302 if an object had not been detected within the safety range in steps 304 or 308. Likewise, in some embodiments the emitted adjusted emission control pulse set of step 324 is adjusted to have an extended time delay period before it is emitted compared to the emission control pulse set that would have been emitted in the next step 302 if an object had not been detected within the safety range in steps 304 or 308. Finally, in some embodiments the emitted adjusted emission control pulse set of step 324 is adjusted to have both an extended time delay period before it is emitted and a further reduced energy level compared to the emission control pulse set that would have been emitted in the next step 302 if an object had not been detected within the safety range in steps 304 or 308.

Each of these embodiments can provide significant performance improvements over past techniques for providing eye-safety. Specifically, by selectively delaying with variable timing and/or further reducing the energy level of an adjusted emission control pulse set that follows the detection of an object in the safety range, these embodiments facilitate an increase in the energy level of the previous emission control pulse sets while maintaining the desired level of eye safety. As was noted above, to provide a level of eye safety the total energy of the emission control pulse sets over specific time frames should be considered. For example, the IEC 60825.1 specification defines the eye-safety of pulses at least in part by the amount of energy that is emitted by two or more pulses over a set of specific time frames while there remains a possibility of an object in the safety range.

In such a regulatory environment, selectively delaying and/or further reducing the energy level of an adjusted emission control pulse set that follows the detection of an object in the safety range allows that the preceding emission control pulse sets be emitted with higher energy while maintaining eye safety for both pulse sets taken together. Stated another way, because the adjusted emission control pulse sets emitted in step 324 are delayed and/or further reduced in energy, the emission control pulse sets emitted in steps 302 can have relatively higher energy while maintaining eye safety for both pulse sets taken together. Furthermore, this increased energy in the emission control pulse sets emitted in steps 302 provides for improved reliability in detecting objects in the safety range Thus improved reliability of detection of objections in the safety range itself provides improved eye safety.

At step 326 it is determined if an object was detected within a safety range with the adjusted emission control pulse set. Again, in one embodiment a detector is configured to receive reflections of the laser light pulses from objects within the scan field. The received reflections of the laser light pulses can then be used to detect those objects and determine the distance to those objects. Thus, any received reflections of the emission control pulse set can be used to determine if there is an object with a designated safety range.

If no object is detected within the safety range, the method 320 proceeds to step 328 where it is determined if additional adjusted emission control checks are required. If no additional adjusted emission control checks are required, the method returns to step 302, where a next emission control (EC) pulse set(s) is emitted. In this performance of step 302 the emission control pulse set can include a second time period following either the second emission control pulse set or the adjusted second emission control pulse set and a reduced third energy level. Steps 302, 304, 306, 308 and 310 can then be continuously repeated to generate measurement distances for different measurement points in the scan field as long as no objects are detected within the safety range.

If an object is detected within the safety range at step 326 the method 300 returns to step 324. At step 324 an adjusted emission control (AEC) pulse set(s) is again emitted. And again, the adjusted emission control pulse set is a set of laser light pulses having a combined reduced energy level provided to determine if any objects are within a relatively close safety range. However, in this additional performance of step 324 the adjusted emission control pulse set can again be modified relative to the emission control pulse set emitted that would have been emitted in the next step 302 if no object had been detected in the safety range in step 326.

Thus, the emitted adjusted emission control pulse set of step 324 is adjusted to have an extended time delay period before it is emitted and/or a further reduced energy level compared to the emission control pulse set that would have been emitted in the next step 302 if an object had not been detected within the safety range in step 326.

Returning to step 328, as described above, this step determines if additional adjusted emission control checks are required. If additional adjusted emission control checks are required, the method returns to step 324 to emit an additional emission control (AEC) pulse set. If no additional adjusted emission control checks are required, the method instead returns to step 302.

Such an embodiment can be implemented in a variety of ways. For example, the technique can be implemented by providing a counting variable to track the number of adjusted emission control pulse sets that have been emitted since the last detection of an object in the safety range. Only when the desired number of adjusted emission control pulse sets have been emitted without an additional detection of an object in the safety range does the method returns to step 302 instead of step 324. In some embodiments, the number of additional emission control pulse sets required can be dynamically altered based on a variety of operational parameters, including the measured distance to the last detected object in the safety range, the number of previous object detections in the safety range, the ambient conditions, the speed of vehicle using the scanning laser device, etc.

Each of these embodiments can provide significant performance improvements by facilitating an increase in the energy level of the previous emission control pulse sets while maintaining the desired level of eye safety. This increased energy in the emission control pulse sets emitted in steps 302 again provides for improved reliability in detecting objects in the safety range.

It should be noted that the adjusted emission control process 322 (i.e., steps 324, 326, and 328) can be continually performed when an object is repeatedly detected in the safety range. In this case adjusted emission control pulse sets are emitted in each step 324 in response to detecting objects in the safety range in corresponding steps 326. And in each case the amount of adjustment (e.g., change in time period before the pulse set and/or energy level of pulse set) can be modified. For example, the amount of adjustment can be based on the number of times these steps have been performed. Such an adjustment allows for the combined energy of all emission control pulse sets emitted when an object may be in the sensing region to be under the limits for the corresponding total time period of the emission control pulse sets.

Turning now to FIG. 4F, graph 360 illustrates the energy and timing of emission control pulse sets and ranging pulse sets in an exemplary operational scenario when an object is detected in a safety range with an emission control pulse set.

Specifically, graph 360 illustrates the energies 362, 364 and 366 of three first emission control (1EC) pulse sets, energy 368 of a second emission control (2EC) pulse set and the energy 370 of a following ranging pulse set. As will be described in greater detail below, FIG. 4F illustrates an example of the pulse sets emitted during method 320 of FIG. 3A.

In this example, a first emission control (1EC) pulse set having energy 362 is emitted to detect any possible objects within a first safety range (e.g., performing step 302 of method 320). This results in the detection of an object 372 in the first safety range (e.g., step 304). Thus, no second emission control (2EC) pulse set and no ranging pulse set is emitted for the current measurement point.

Instead, an adjusted emission control (AEC) pulse set having energy 364 is emitted for a next measurement point to again detect any possible objects within the first safety range (e.g., performing step 324 of method 320). This time there is no detection of an object in the first safety range (e.g., performing step 326) and no further adjusted emission control checks are required (e.g., performing step 328).

Thus, a next first emission control (1EC) pulse set having energy 366 is emitted for a next measurement point to again detect any possible objects within the first safety range (e.g., reperforming step 302 of method 320). This does not result in the detection of an object in the first safety range (e.g., step 304). Thus, a second emission control (2EC) pulse set having energy 326 is emitted to detect any possible objects within the second safety range (e.g., step 306). This does not result in the detection of an object in the second safety range (e.g., step 308). Thus, a ranging pulse set having energy 370 is emitted (e.g., step 310).

Notably, in this example the adjusted first emission control (A1EC) pulse set with energy 364 is emitted after a delay, i.e., after an extended first time period. Specifically, this extended first time period is longer than the corresponding first time period when no object is detected. Selectively delaying the adjusted emission control pulse set that follows the detection of an object in the safety range facilitates that the preceding emission control pulse sets be emitted with higher energy while maintaining eye safety for both of the emission control pulse sets taken together. This increased energy in the previous emission control pulse sets provides for improved reliability in detecting objects in the safety range, and thus can provide improved eye safety.

Finally, it should be noted that in the example of FIG. 4F that after a detection of an object in the safety range with the first emission control pulse set that two first emission control pulse sets without another detection were required before a second emission control pulse set was again emitted. Again, requiring two clear pulse sets after a detection can further increase the reliability of the emission control system by increasing the probability that an object in the safety range is detected before higher energy pulse sets are emitted.

In other embodiments the adjusted first emission control (A1EC) pulse set could be emitted with a further reduced energy level. Specifically, this reduced energy level is less than corresponding energy level when no object is detected (e.g., the energy 362). This further reduction in energy level can be instead of or in addition to the additional delay provided by the extended first time period.

Turning now to FIG. 4G, graph 380 illustrates an example where the energy and timing of emission control pulse sets where the adjusted emission control pulse sets have both extended delay and a further reduced energy level 382. Selectively further reducing the energy level of the adjusted emission control pulse set that follows the detection of an object in the safety range facilitates that the preceding emission control pulse sets be emitted with higher energy while maintaining eye safety for both of the pulse sets taken together. This increased energy in the previous emission control pulse sets again provides for improved reliability in detecting objects in the safety range, and thus can provide improved eye safety.

Next it should be noted that while FIGS. 4F and 4G show adjusted first emission control (A1EC) pulse sets that similar adjustments can be made to the timing and energy levels or the second emission control pulse sets in response to object detections in the second safety range. And again, in such embodiments multiple clear emission control pulse sets after a detection can be required in some embodiments to further increase the reliability of the emission control system by increasing the probability that an object in the safety range is detected before higher energy pulse sets are emitted.

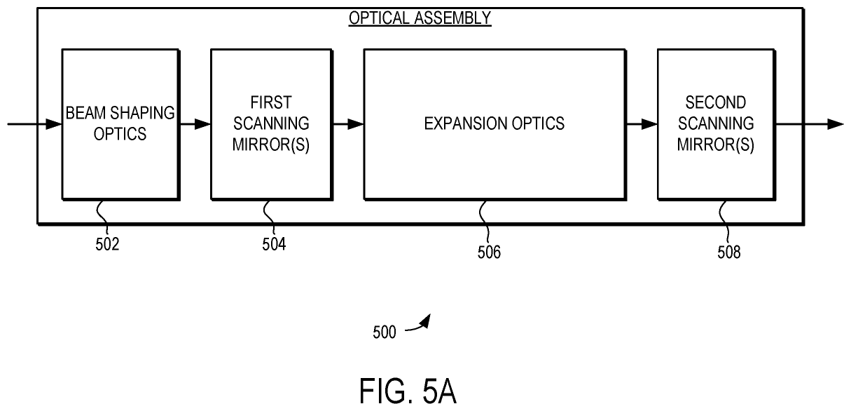

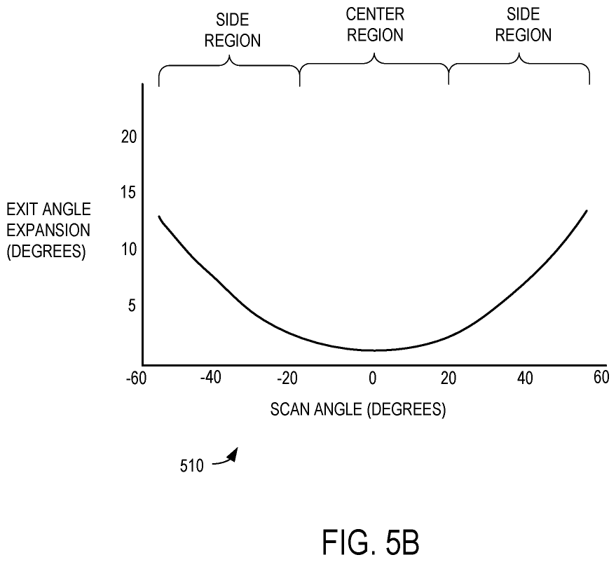

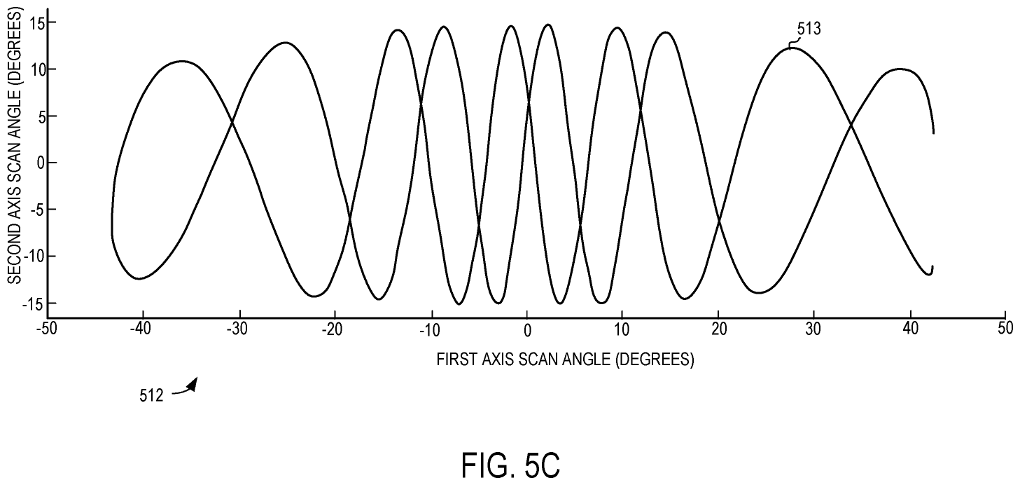

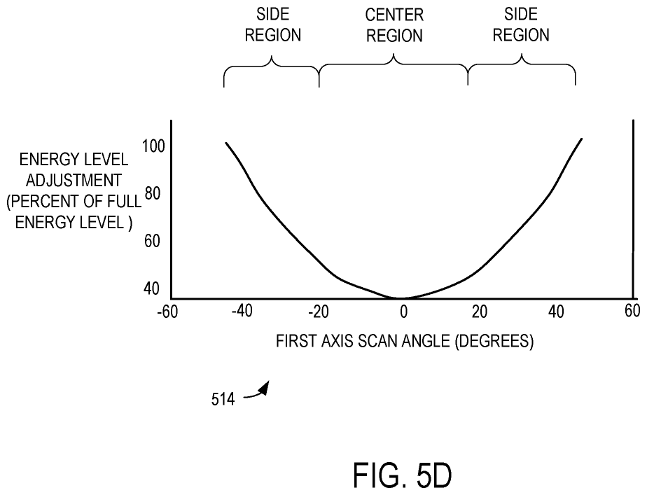

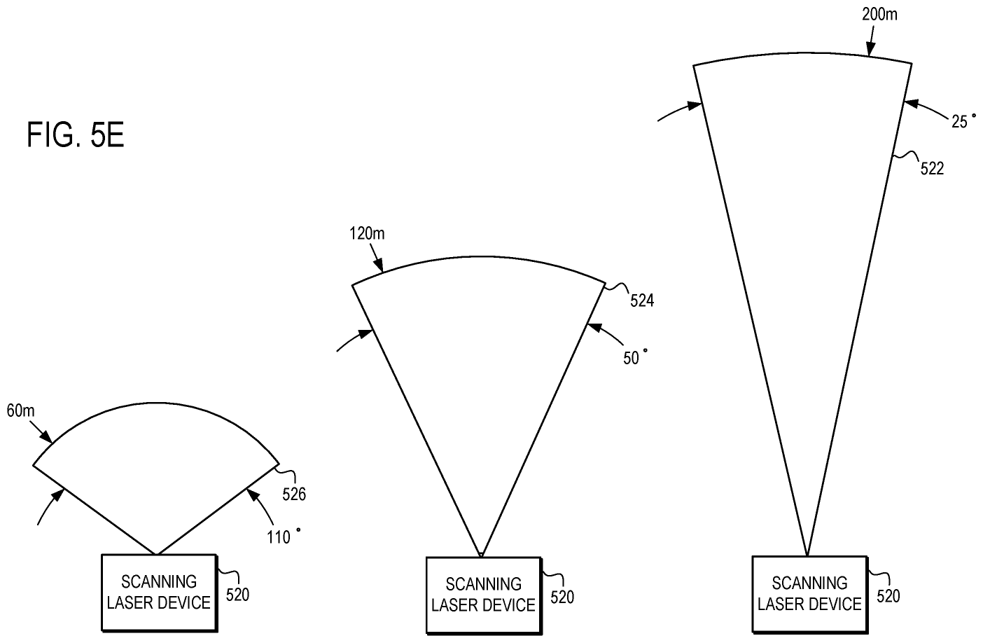

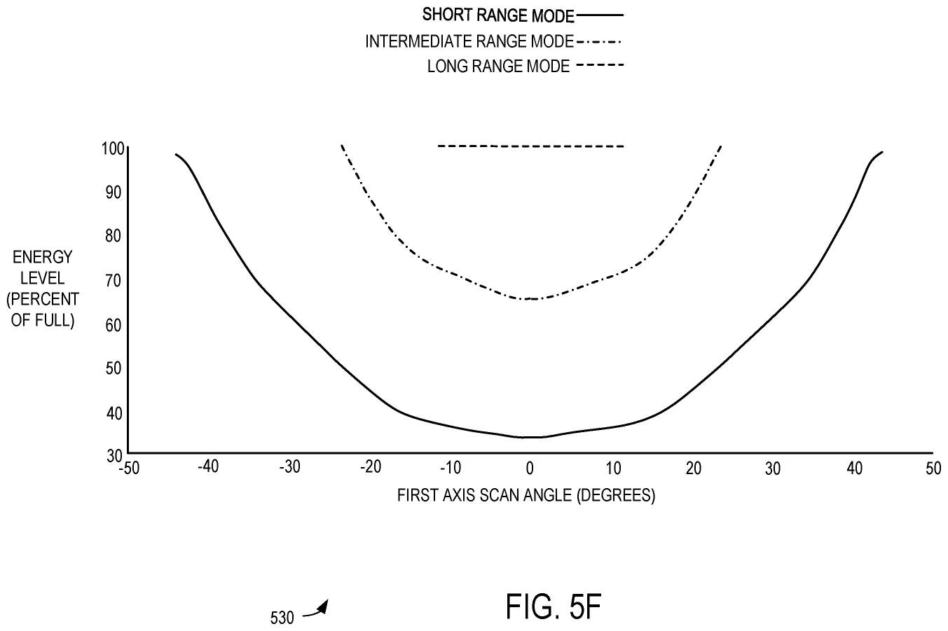

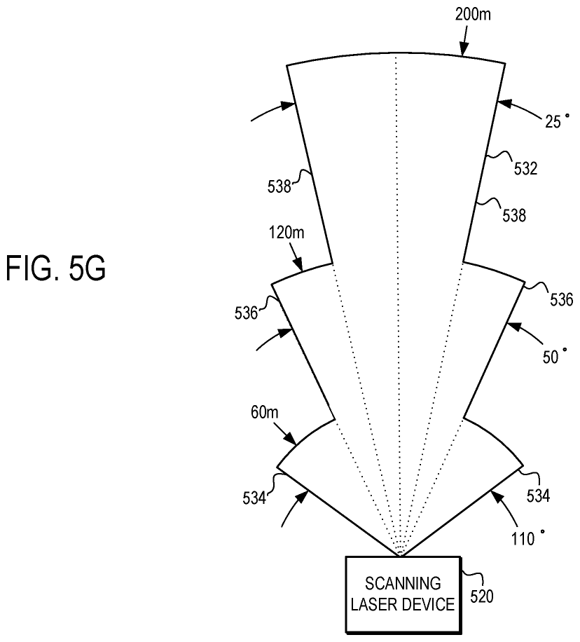

Turning now to FIGS. 5-12, a variety of detailed examples of exemplary scanning laser devices will be described. These examples include various specific embodiments of the type of scanning laser devices that can be implemented emission control in accordance with the embodiments described herein. However, it should be noted that these are just non-limiting examples of the type of scanning laser devices that can be so implemented with the emission control methods described above.

Turning now to FIG. 5A, a more detailed embodiment of an optical assembly 500 is illustrated. The optical assembly 500 includes optical elements used for scanning laser beam pulses over a scan field. The optical assembly 500 is an example of the type of optical assembly that can be used in a LiDAR or other scanning laser device (e.g., scanning laser device 100, 200) in accordance with the embodiments described herein. The optical elements illustrated in FIG. 5A includes beam shaping optics 502, first scanning mirror(s) 504, expansion optics 506, and second scanning mirror(s) 508, although this is just one non-limiting example. Again, during operation of a scanning laser device a laser light source generates laser light pulses that are scanned by the optical assembly 500 into a scan trajectory (e.g., scan trajectory 112) over a scan field (e.g., scan field 114).

For example, the laser light source can comprise one or more infrared (IR) lasers implemented to generate IR laser light pulses. In one specific example, the pulses from multiple IR laser light sources are combined and shaped by beam shaping optics 502. The beam shaping optics 502 can include any optics for changing the beam shape of the laser light pulses. For example, the beam shaping optics 502 can include optical elements for changing the beam shape, changing the beam collimation, combining multiple beams, and aperturing the beam(s).

The output of the beam shaping optics 502 is passed to the first scanning mirror 504. In general, the first scanning mirror 504 provides for one axis of motion (e.g., horizontal), while the second scanning mirror 508 provides for another, typically orthogonal, axis of motion (e.g., vertical). Thus, the first scanning mirror 504 scans the laser beam pulses across one direction (e.g. horizontal), while the second scanning mirror 508 scans across the other direction (e.g., vertical). Furthermore, in a typical implementation of such an embodiment, the first scanning mirror 504 is operated to provide the scanning motion at one rate (e.g., a relatively slow scan rate), while the second scanning mirror 508 is operated to provide motion at a different rate (e.g., a relatively fast scan rate). Together, this results in the laser light pulses being scanned into scan trajectory (e.g., scan trajectory 112). It further be noted labels “vertical” and “horizontal” used herein are somewhat arbitrary, since a 90 degree rotation of the scanning laser device will effectively switch the horizontal and vertical axes.

The output of the first scanning mirror 504 is passed to the expansion optics 506. In general, the expansion optics 506 are implemented to provide an expansion of the scan field in one or more directions. For example, the expansion optics 506 can be implemented to provide an angular expansion along the axis of motion of the first scanning mirror 504. Thus, in one example where the first scanning mirror 504 provides relatively slow speed scanning along the horizontal axis, the expansion optics 506 can be implemented to increase the scanning angle along in the horizontal direction. As one specific example, the first scanning mirror 504 can be implemented to provide a scanning angle in the horizontal direction of 40 degrees, and the expansion optics 506 can be implemented to expand the scanning angle to 110 degrees, thus expanding the size of the resulting scan trajectory and scan field.

To provide this expansion the expansion optics 506 can be implemented with one or more lenses, with the one or more lenses configured to together provide the desired angular expansion. In one specific example, the expansion optics 506 is implemented with three separate lenses. A description of such an embodiment will be described in greater detail below.

The output of the expansion optics 506 is passed to the second scanning mirror 508. Again, the first scanning mirror 504 provides for one axis of motion (e.g., horizontal), while the second scanning mirror 508 provides for another, typically orthogonal, axis of motion (e.g., vertical). Furthermore, the first scanning mirror 504 and second scanning mirror 508 operate at different scan rates. In one specific embodiment the second scanning mirror 508 provides vertical high rate scanning, while the first scanning mirror 504 provides horizontal low rate scanning.

During operation, optical assembly 500 thus operates to receive laser light pulses and scan those laser light pulses into a scan trajectory pattern inside a scan field.

Turning now to FIG. 5B, a representation of optical expansion in a scan field is illustrated in graph 510. Specifically, graph 510 shows the exit pointing angle expansion as a function of the scan angle along a first axis, where the first axis also corresponds to a first axis in the resulting scan field. This exit angle expansion is an example of the type of optical expansion that can be provided by the expansion optics of a scanning laser device (e.g., expansion optics 108 of FIG. 1, expansion optics 506 of FIG. 5A). The optical expansion illustrated in graph 510 is non-uniform relative to a first axis, and more specifically results in a non-linear optical expansion relative to an axis in the scan field. This non-uniform and non-linear optical expansion results in a higher rate of optical expansion variation in the side regions of the scan field along the first axis compared to the lower rate of optical expansion variation in the center region. This is shown by the increasingly steep slopes of the function curve as distance from the center increases.

Turning now to FIG. 5C, a graph 512 illustrates an exemplary scan trajectory 513. During operation of the scanning laser device laser light pulses impact objects in a series of scan locations or measurement points along the scan trajectory 513. The scan trajectory 513 is an example of the type of scan trajectory that can be generated with a scanning laser device that includes expansion optics that provide a non-uniform optical expansion with respect to a first axis (e.g., expansion optics 108 of FIG. 1, expansion optics 506 of FIG. 5A). More specifically, the scan trajectory 513 is an example of the type of trajectory that can be generated with an optical expansion such as that illustrated in graph 510 of FIG. 5B. Thus, this scan trajectory 513 shows the result of a non-uniform and non-linear optical expansion where a higher rate of exit angle expansion variation is created in the side regions of the scan field along the first axis compared to the lower rate of exit angle expansion variation created in the center region.

The scan trajectory 513 is generated by the motion of one or more scanning mirror(s), with the mirror(s) providing deflection of the laser light pulses along a first axis and a second axis, with the non-uniform expansion provided by one or more expansion optics. In this illustrated example, the scanning motion in the first axis is relatively slow motion, while the scanning motion in the second axis is relatively fast motion. Also, in this example the motion in the first axis is horizontal, while the motion in the second axis is vertical (although again it should be noted that the labels “vertical” and “horizontal” are somewhat arbitrary).

Finally, it should be noted that the scan trajectory 513 is just one example trajectory that can result from non-uniform variations in optical expansion, and that many other implementations are possible.

As described above, a variation in the optical expansion such as that illustrated in FIGS. 5B and 5C can result in a variation in the effective range of the scanning laser detector. Specifically, a variation in optical expansion will result in a variation in beam width and beam divergence, which in turn can result in a variation in the effective range of the scanning laser device. Thus, in some embodiments the light source controller (e.g., light source controller 101) is configured to vary the energy level of the laser light pulse sets to provide the desired effective range of the sensor by at least partially compensating for the effects of the non-uniform optical expansion provided by the expansion optics.

Turning now to FIG. 5D, a representation of laser light pulse set energy level adjustment is illustrated in graph 514. Specifically, graph 514 shows the energy level adjustment as a function of the scan angle along a first axis, where the first axis also corresponds to a first axis in the resulting scan field. Notably, this illustrated energy level adjustment can be considered to be an increased percentage in energy level from a low power state or as a decreased percentage in energy level from a high power state.

Again, in one embodiment the light source controller (e.g., light source controller 101) is configured to vary the energy in a manner proportional to the non-uniform variation in optical expansion. Again, such variation can be applied to either the long-range ranging pulse sets, the short-range emission control pulse sets, or both. Thus, laser light pulses that are subjected to greater optical expansion are generated with greater energy levels and vice versa. This increase in energy level compensates for the reduction in effective range that would otherwise occur due to the increasing amounts of optical expansion to provide a desired effective range of the detector and the scanning laser device.

As described above, in some embodiments the scanning laser device (e.g., scanning laser device 100) is implemented to provide an improved effective range that varies over the scan field, with different effective ranges in different areas of the scan field. In these embodiments these different effective ranges are facilitated by varying the energy level of the laser light pulse sets in a manner that both adjusts the energy level for desired effective range in an area of the scan field and the amount of optical expansion in that area of the scan field.

Turning now to FIG. 5E, a schematic view of a scanning laser device 520 is illustrated. Specifically, FIG. 5E shows the scanning laser device 520 that is implemented with three different exemplary scan fields 522, 524 and 526, where the three different scan fields 522, 524 and 526 each have different effective ranges and different angular fields of view. As one example, these different effective ranges can be provided by implementing the scanning laser device 520 to operate in different modes at different times during operation, where each of the different modes has a different range and/or different angular field of view. For example, the scanning laser device 520 can be implemented to alternate or otherwise switch between different range modes in response to a variety of factors. In other embodiments that will be discussed in greater detail below, the scanning laser device 520 can be implemented provide these different ranges during different portions of the same scan trajectory.

In the example of FIG. 5E there are three range modes, a close-range mode, an intermediate-range mode, and a long-range mode. In this example, the close-range mode provides a scan field 526 with an effective range of 60 meters and an angular scan field of 110 degrees. The intermediate-range mode provides a scan field 524 with an effective range of 120 meters and an angular scan field of 50 degrees. Finally, the long-range mode provides a scan field 522 with an effective range of 200 meters and an angular scan field of view of 25 degrees. Of course, these are just examples, and other implementations are possible.

To implement these different range modes in the scanning laser device 520, a light source controller (e.g., light source controller 101) would vary the energy levels of the laser light pulse sets to achieve the desired range. The three different angular extents of the scan fields 522, 524 and 526 can be achieved for these three modes by dynamically changing the angular range of mirror deflection. In other embodiments the angular range of mirror deflection can remain constant and the angular extents of the scan fields 522, 524 and 526 changed by selectively not transmitting laser light pulses when the mirror is outside the desired angular extent for the desired angular scan field. In either case the scanning laser device 520 can provide the desired effective range and desired angular extents of the scan field for each different operating mode.

It should be noted that each of the close-range mode, intermediate-range mode, and long-range mode could be implemented to the same or different safety ranges for emission control. Thus, in some examples, the first safety range and second safety range for which objects are detected by emission control pulse sets could be different for each mode. As such, the energy for the first and second emission control pulse sets could be varied to provide these different safety ranges.

Turning now to FIG. 5F, a representation of laser light pulse set energy levels is illustrated in graph 530. The graph 530 shows laser light pulse set energy levels for three range modes, i.e., a long-range mode, intermediate-range mode, and a close-range mode. These modes correspond to the exemplary scan fields 522, 524 and 526 illustrated in FIG. 5E. Thus, in long-range mode the scanning laser device 520 is operated to have a range of 200 meters with a relatively narrow 25 degree field of view. In intermediate-range mode the scanning laser device 520 is operated to have a range of 120 meters and a 50 degree field of view. In close-range mode the scanning laser device 520 is operated to have a range of 60 meters and a relatively wide 110 degree field of view. Accordingly, the energy level of the laser light pulse sets is adjusted to provide these desired ranges, while also accounting for any non-uniform optical expansion provided by the expansion optics.

The graph 530 shows the energy level adjustment for three different modes as a function of the scan angle along a first axis, where the first axis also corresponds to a first axis in the resulting scan field. In this case the light source controller (e.g., light source controller 101) is configured to provide a relatively constant high energy level for the long-range mode as the relatively narrow field of view limits the optical expansion of these pulses. In this example the energy level for the laser light pulse sets is at or near 100% of full pulse energy.

However, for the intermediate-range and close-range modes the light source controller is configured to vary the energy in a manner proportional to the non-uniform variation in optical expansion over the angular range covered by that mode. This allows the desired range to be achieved for both modes while compensating for the effects of the non-uniform optical expansion.

The examples of FIGS. 5E and 5F show a scanning laser device 520 implementations where there are separate modes with different effective ranges and different angular scan fields 522, 524 and 526. Again, in such an implementation the scanning laser device 520 could be implemented to switch between modes in a variety of patterns and/or based on a variety of factors. In those examples each mode had a relatively constant range across its respective scan field. However, in other embodiments, the scanning laser device 520 can instead be implemented provide these different ranges during different portions of the same scan frame, effectively providing dynamic range shaping over the scan field. To facilitate this scanning laser device 520 can be implemented to change the effective range at various points within each scan trajectory or scan frame. Thus, at these points within the scan trajectory the effective range can be increased or decreased to dynamically achieve the desired ranges over the scan field.

Turning now to FIG. 5G, a schematic view of a scanning laser device 520 with multiple effective ranges is illustrated. Specifically, FIG. 5G shows the scanning laser device 520 that is implemented to provide a scan field 532 that has three different effective ranges different ranges over different angular regions of the scan field 532. Again, such dynamic range shaping can be accomplished by implementing the scanning laser device 520 to adjust the pulse energy at different points within the scan trajectory.

Specifically, in the example of FIG. 5G the scan field 532 has close-range regions 534 that have a range of 60 meters and correspond to expansion output angles between 25 and 55 and −25 and −55 degrees. The scan field 532 likewise has intermediate-range regions 536 that have a range of 120 meters and correspond to expansion output angles between 12.5 and 25 degrees and −12.5 and −25 degrees. Finally, the scan field 532 has long-range regions 538 that have a range of 200 meters and correspond to expansion angles between 0 and 12.5 degrees and 0 and −12.5 degrees. Thus, the scanning laser device 520 provides three different ranges over each scan trajectory or scan frame.

It should be noted that the example of FIG. 5G can be considered a superposition of the three range modes illustrated in FIG. 5E. Specifically, this example also provides a “long-range area” (e.g., a center region with a range of 200 meters), an “intermediate-range area” (e.g., intermediate regions with a range of 120 meters), and a “close-range area” (e.g., outer regions with a range of 60 meters) over each scan trajectory. The scanning laser device 520 can accomplishes this dynamic range shaping by varying the pulse set energy to change effective ranges at 25, 12.5-12.5 and −25 degrees while also varying the pulse set energy to compensate for any effects of the non-uniform optical expansion provided by the expansion optic.

Again, it should be noted that the scanning laser device could be implemented to use the same or different safety ranges for each of these different areas or angular regions. Thus, in some examples, the first and second safety ranges for which objects are detected by the first and second emission control pulse sets could be different for each of these different areas or angular regions range. As such, the energy for the emission control pulse sets could be varied to provide these different safety ranges.

While the scanning laser device 520 illustrated in FIG. 5G provides a scan field 532 with three different effective ranges, this is just one example implementation and others are possible. For example, the scanning laser device can be implemented with a greater number of effective ranges. Furthermore, the number of ranges and the ranges can be asymmetrical, horizontally and/or vertically.

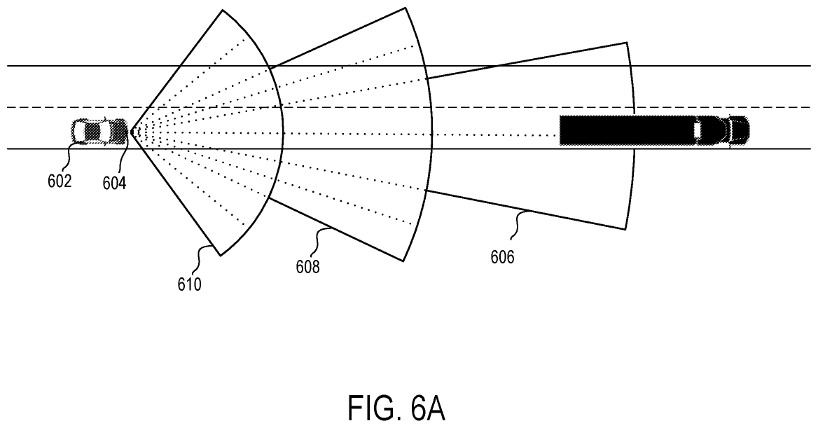

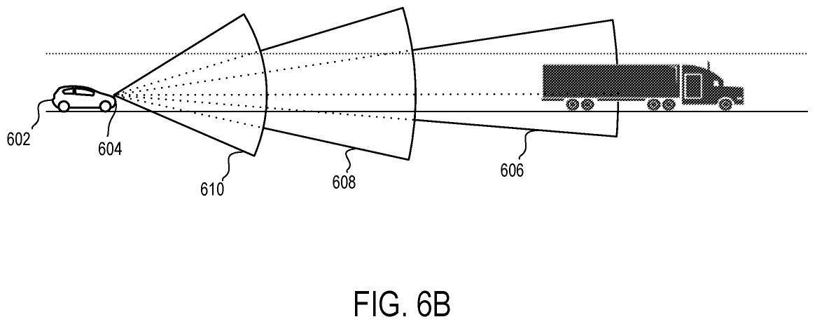

Turning now to FIGS. 6A and 6B, one application of a scanning laser device (e.g., scanning laser device 100) is illustrated. Specifically, FIGS. 6A and 6B illustrate a moving platform with scanning LiDAR system in accordance with various embodiments. Automobile 602 is a movable platform upon which a LiDAR system 604 is mounted. The LiDAR system is implemented using the various embodiments discussed above. (e.g., scanning laser device 100 of FIG. 1) or any of the scanning laser devices and LiDAR systems discussed herein.

The LiDAR system 604 generates an exemplary scan field where different horizontal regions have different effective ranges. Specifically, as illustrated in FIGS. 6A and 6B the LiDAR system 604 can be implemented to selectively facilitate long-range regions 606, intermediate-range regions 608 and close-range regions 610, with each of these regions having different angular extents. Again, this can be accomplished by operating the LiDAR system 604 in three different range modes, where the three different range modes have different angular fields of view as was illustrated in FIG. 5E. Alternatively, this can be accomplished by operating the LiDAR system 604 to provide dynamic range shaping with different regions having different effective ranges as illustrated in FIGS. 5G and 51-4L.

To implement these different ranges in the LiDAR system 604 a light source controller would vary the energy levels of the laser light pulses and pulse sets (including both ranging and emission control pulse sets) to compensate for the optical expansion of the expansion optics and the different desired ranges. Notably, in some embodiments significant and/or non-uniform optical expansion may be provided in one or both axis. In those embodiments any variation in energy to compensate for the optical expansion would only occur in axis with significant optical expansion.

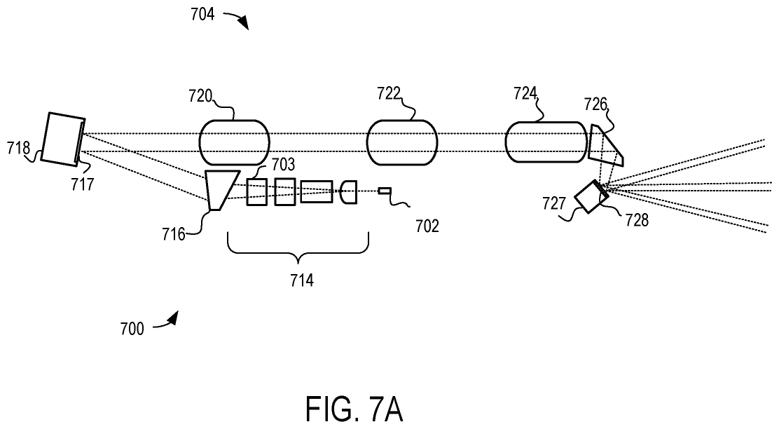

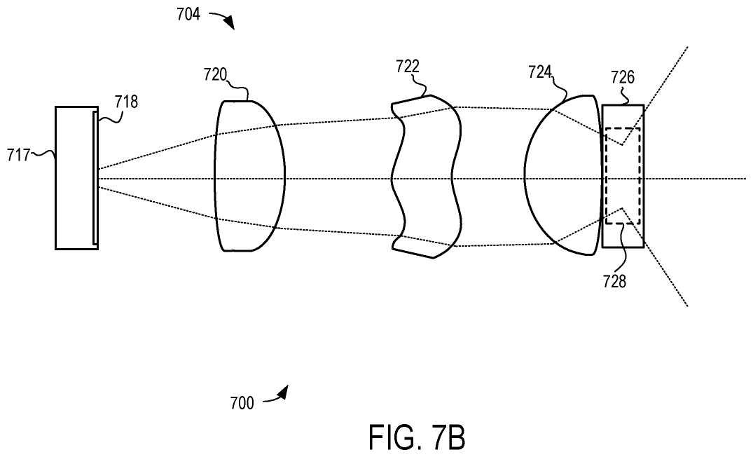

Turning now to FIGS. 7A and 7B, side and top views of an exemplary scanning laser device 700 are illustrated. The scanning laser device 700 is an example of the type of device that can be implemented with emission control techniques described above (e.g., methods 300 and 320). As such, scanning laser device 700 can be implemented selectively emit relatively low energy first and second emission control pulse sets that are used to detect when objects (e.g., persons) are within a first and second relatively close safety ranges and then conditionally emit long-range ranging pulse sets only when objects are not detected within the first and second safety ranges, thus improving eye-safety.

In one embodiment, the scanning laser device 700 is a light LiDAR system used for object detection and/or 3D map generation. The scanning laser device 700 includes a laser light source 702 and an optical assembly 704. The optical assembly 704 is one example of the type of optical assembly that can be used in a LiDAR or other scanning laser device (e.g., scanning laser device 100) in accordance with the embodiments described herein. As such, the optical assembly 704 includes a variety of optical elements used to facilitate scanning. It should be noted that FIGS. 7A and 7B are simplified examples, and thus do not show all of the elements or features of a fully implemented scanning laser device or optical assembly.

The optical assembly 704 illustrated in FIG. 7A includes beam shaping optics 714, a first prism 716, a first scanning mirror assembly 717, first scanning mirror(s) 718, expansion optics that include three expansion lenses 720, 722, 724, a second prism 726, a second scanning mirror assembly 727, and second scanning mirror(s) 728.

During operation of scanning laser device 700 the laser light source 702 generates laser light pulses that are scanned by the optical assembly 704 into a scan trajectory. For example, the laser light source 702 can comprise one or more infrared (IR) lasers driven by field effect transistors (FETs) to generate IR laser light pulses.

In general, pulses from multiple IR laser light sources are first combined and shaped by the beam shaping optics 714 and associated optical elements. The beam shaping optics 714 can thus include any optics for changing the beam shape of the laser light pulses. For example, the beam shaping optics 714 can include collimating lenses, polarizing combiners, anamorphic prism pairs to improve divergence and other such elements. In one embodiment a pick-off beam splitter or prism 703 is implemented within the beam shaping optics 714 to direct reflections to the detector (not shown in FIGS. 7A and 7B) configured for relatively short-range pulse detection.

The output of the beam shaping optics 714 is passed to first prism 716 that kicks the beams up to the first scanning mirror 718. In this illustrated embodiment, the first scanning mirror 718 provides for horizontal scanning motion, while the second scanning mirror 728 provides for vertical scanning motion. Furthermore, in this example the first scanning mirror 718 is driven to provide the scanning motion at a relatively slow scan rate, while the second scanning mirror 728 is driven to provide motion at a relatively slow scan rate. However, these are just examples, and other implementations are possible. Together, this scanning mirror motion results in the laser light pulses being scanned into scan trajectory. It again should be noted labels “vertical” and “horizontal” used herein are somewhat arbitrary, since a 90 degree rotation of the scanning laser device will effectively switch the horizontal and vertical axes.

The output of the first scanning mirror 718 is passed to the three expansion lenses 720, 722, 724 which together provide the expansion optics. In general, the expansion optics are implemented to provide an expansion of the scan field in the horizontal direction.

Specifically, in this illustrated example the three expansion lenses 720, 722, 724 are implemented to image the output of the first scanning mirror 718 onto the second scanning mirror 728 while providing a non-uniform expansion in the horizontal direction. As one specific example, the first scanning mirror 718 can be implemented to provide a scanning angle in the horizontal direction of 40 degrees, and the expansion lenses 720, 722, 724 can be implemented to provide a non-uniform expansion to expand the scanning angle to 110 degrees.

In one specific example, the three expansion lenses 720, 722, 724 implement a 4F optical system that images the output of the first scanning mirror 718 onto the second scanning mirror 728. Specifically, the three expansion lenses 720, 722, 724 provide a 4F optical system with magnification that varies with the angle coming from the first scanning mirror 718. The result of these three expansion lenses 720, 722, 724 is a non-uniform variation in optical expansion of the exit scan angle provided by the first scanning mirror 718. The second prism 726 receives the output of the third expansion lens 724 and directs the beams to the second scanning mirror 728.

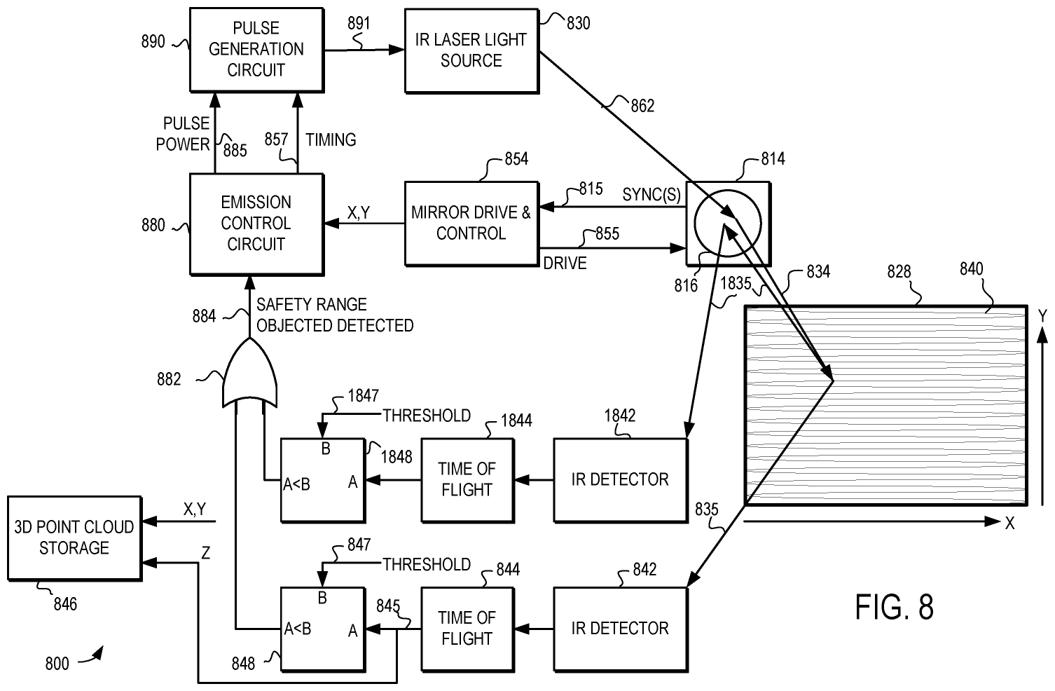

Turning now to FIG. 8, a scanning light detection and ranging (LiDAR) system 800 in accordance with various embodiments is illustrated. System 800 includes pulse generation circuit 890, infrared (IR) laser light source 830, scanning mirror assembly 814 with scanning mirror(s) 816, and mirror drive and control circuit 854. System 800 also includes first infrared (IR) detector 842, first time-of-flight (TOF) measurement circuit 844, 3D point cloud storage circuit 886, first comparator 848, and emission control circuit 880. System 800 also includes second IR detector 1842, second TOF measurement circuit 1844, and second comparator 1848. As will be described in greater detail below, the second IR detector 1842 can be implemented to provide redundant relatively short-range detection.

The LiDAR system 800 is another example of the type of scanning laser device that can be implemented in accordance with the embodiments described herein (e.g., methods 300, 350, 360). In this example, the emission control circuit 880 and pulse generation circuit 890 function as all or part of a light source controller, and thus controls the laser light source 830 to selectively emit relatively low energy emission control pulse sets (e.g., first and second emission control pulses) that are used to detect when objects (e.g., persons) are within relatively close safety ranges (e.g., first and second safety ranges). Then, higher energy long-range pulse sets are conditionally emitted only when objects are not detected within the first and second safety ranges, thus improving eye-safety.

Laser light source 830 may be a laser light source such as a laser diode(s) or the like, capable of emitting a laser beam pulses 862. The beam pulses 862 impinge on a scanning mirror assembly 814 which in some embodiments is part of a microelectromechanical system (MEMS) based scanner or the like, and reflects off of scanning mirror 816 to generate controlled output beam pulses 834. In some embodiments, optical elements are included in the light path between laser light source 830 and mirror(s) 816. For example, system 800 may include collimating lenses, dichroic mirrors, expansion optics, or any other suitable optical elements. And as was described above, the scanning mirrors, expansion optics, and other elements can cause back reflections of laser light pulses toward the second IR detector 1842 during operation of the system 800.

A scanning mirror drive and control circuit 854 provides one or more drive signal(s) 855 to control the angular motion of scanning mirror(s) 816 to cause output beam pulses 134 to traverse a scan trajectory 840 in a scan field 828. In operation, laser light source 830 produces modulated light pulses in the nonvisible spectrum and scanning mirror(s) 816 reflect the light pulses as beam pulses 834 traverse scan trajectory 840.

In some embodiments, scan trajectory 840 is formed by combining a sawtooth component on the horizontal axis and a sinusoidal component on the vertical axis. In still further embodiments, the horizontal sweep is also sinusoidal. The various embodiments of the present invention are not limited by the waveforms used to control the vertical and horizontal sweep or the resulting scan trajectory pattern. One axis (e.g., horizontal) is the slow scan axis, and the other axis is the fast-scan axis.

Although scanning mirror(s) 816 are illustrated as a single mirror that scans in two axes, this is not a limitation of the present invention. For example, in some embodiments, mirror(s) 816 is implemented with two separate scanning mirrors, one scanning in one axis, and a second scanning in a second axis.

In some embodiments, scanning mirror(s) 816 include one or more sensors to detect the angular position or angular extents of the mirror deflection (in one or both dimensions). For example, in some embodiments, scanning mirror assembly 814 includes a piezoresistive sensor that delivers a voltage that is proportional to the deflection of the mirror on the fast-scan axis. Further, in some embodiments, scanning mirror assembly 814 includes an additional piezoresistive sensor that delivers a voltage that is proportional to the deflection of the mirror on the slow-scan axis. The mirror position information is provided back to mirror drive and control circuit 854 as one or more SYNC signals 815. In these embodiments, mirror drive and control circuit 854 includes one or more feedback loops to modify the drive signals in response to the measured angular deflection of the mirror. In addition, in some embodiments, mirror drive and control circuit 854 includes one or more phase lock loop circuits that estimate the instantaneous angular position of the scanning mirror based on the SYNC signals.

Mirror drive and control circuit 854 may be implemented using functional circuits such as phase lock loops (PLLs), filters, adders, multipliers, registers, processors, memory, and the like. Accordingly, mirror drive and control circuit 854 may be implemented in hardware, software, or in any combination. For example, in some embodiments, control circuit 854 is implemented in an application specific integrated circuit (ASIC). Further, in some embodiments, some of the faster data path control is performed in an ASIC and overall control is software programmable.

The system 800 includes two separator IR detectors, TOF measurement circuits and comparators for detecting IR laser pulses. Specifically, the system 800 includes a first IR detector 842 and a second IR detector 1842. In general, the first IR detector 842 is implemented to detect reflections from both emission control pulse sets (e.g., first and second emission control pulse sets) and ranging pulse sets, while the second IR detector provides for the redundant detection of reflections from the low power emission control pulse sets to provide increased eye safety.

First IR detector 842 includes one or more photosensitive devices capable of detecting reflections of IR laser light pulses. For example, first IR detector 842 may include one or more PIN photodiodes, Silicon photomultipliers (SiPM), avalanche photodiodes (APD), or the like. Each point in the field of view that is illuminated with an IR laser light pulse (referred to herein as a “measurement point”) may or may not reflect some amount of the incident light back to first IR detector 842. If first IR detector 842 detects a reflection, IR detector 842 provides a signal 843 to first TOF measurement circuit 844.

First TOF measurement circuit 844 measure times-of-flight (TOF) of IR laser light pulses to determine distances to objects in the field of view. In some embodiments, emission control circuit 880 provides a timing signal (not shown) corresponding to the emission time of a particular IR laser light pulse to first TOF measurement circuit 844, and first TOF measurement circuit 844 measures the TOF of IR laser light pulses by determining the elapsed time between the emission of the pulse and reception of the reflection of the same pulse.

First TOF measurement circuit 844 may be implemented using any suitable circuits. For example, in some embodiments, first TOF measurement circuit 844 includes an analog integrator that is reset when the IR pulse is launched, and is stopped when the reflected pulse is received. First TOF measurement circuit 844 may also include an analog-to-digital converter to convert the analog integrator output to a digital value that corresponds to the time-of-flight (TOF) of the IR laser pulse, which in turn corresponds to the distance between system 800 and the object in the field of view from which the laser light pulse was reflected.

3D point cloud storage device 846 receives X, Y data from mirror drive and control circuit 854, and receives distance (Z) data on node 845 from first TOF measurement circuit 844. A three-tuple (X, Y, Z) is written to 3D point cloud storage device for each detected reflection, resulting in a series of 3D points referred to herein as a “point cloud.” Not every X, Y measurement point in the field of view will necessarily have a corresponding Z measurement. Accordingly, the resulting point cloud may be sparse or may be dense. The amount of data included in the 3D point cloud is not a limitation of the present invention.

3D point cloud storage device 846 may be implemented using any suitable circuit structure. For example, in some embodiments, 3D point cloud storage device 846 is implemented in a dual port memory device that can be written on one port and read on a second port. In other embodiments, 3D point cloud storage device 846 is implemented as data structures in a general purpose memory device. In still further embodiments, 3D point cloud storage device 846 is implemented in an application specific integrated circuit (ASIC).

First comparator 848 compares the distance data (Z) on node 845 to a current threshold value, and if the distance is less than the current threshold value, then first comparator 848 asserts the safety range object detection signal on the input to OR gate 882. The safety range object detection signal passes through OR gate 882 to the emission control circuit 880 to indicate the detection of an object within a first or second safety range, where the first and second safety ranges are determined by values of the threshold on node 847. For example, if a first threshold is set to a value corresponding to a distance of five meters, and the detected distance is lower than that first threshold, then an object closer than five meters has been detected, and emission control circuit 880 will be notified by the safety range object detection signal on node 884. Likewise, if a second threshold is set to a value corresponding to a distance of ten meters, and the detected distance is lower than that second threshold, then an object closer than ten meters has been detected, and emission control circuit 880 will be notified by the safety range object detection signal on node 884.

The threshold values at node 847 and the corresponding safety range distances can be modified by emission control circuit 880 based on any criteria. For example, the thresholds may be a function of IR laser pulse power, pulse duration, pulse density, wavelength, scanner speed, desired laser safety classification, and the like. The manner in which the threshold values are determined is not a limitation.

The second IR detector 1842, second TOF measurement circuit 1844, and second comparator 1848 operate to provide a redundant detection capability for reflections of first and second emission control pulse sets from objects in the first and second safety ranges. Redundant detection of first and second emission control pulse sets provides an additional measure of safety. For example, if one or the IR detectors, TOF measurement circuits, or comparators should fail, the redundancy will ensure continued safe operation.

Notably, the first IR detector 842 and the second IR detector 1842 receive reflected light pulses through different optical paths. Specifically, the first IR detector 842 receives reflected light along a separate path shown at 835 while the second IR detector 1842 shares at least part of an optical path with the emitted light pulses. Specifically, the reflected light from the scan field is reflected back through at least some of the mirror(s) 816, expansion optics, and other elements in the optical assembly to reach second IR detector 1842 along path 1835.

The second TOF measurement circuit 1844 measure times-of-flight (TOF) of IR laser light pulses to determine distances to objects in the field of view in a manner similar to that of the first TOF measurement circuit 844. Thus, the second TOF measurement circuit 1844 may be implemented using any suitable circuits as with the first TOF measurement circuit 844.

Likewise, the second comparator 1848 compares the distance data (Z) on node 845 to a current threshold value, and if the distance is less than the current threshold value, then second comparator 1848 asserts the safety range object detection signal on the input to OR gate 882. Again, this safety range object detection signal passes through OR gate 882 to the emission control circuit 880 to indicate the detection of an object within a relatively short first or second safety range, where first and safety ranges are determined by the values of the threshold on node 1847.

Again, the threshold values at node 1847 and the corresponding safety range distances may be modified by emission control circuit 880 based on any criteria. For example, the threshold may be a function of IR laser pulse power, pulse duration, pulse density, wavelength, scanner speed, desired laser safety classification, and the like.

In some embodiments, both of the detection and TOF measurement circuits operate to detect short-range objects (e.g., objects in the safety range), and only one of the detection and TOF measurement circuits operate to measure long-range distance and/or write to the 3D cloud storage device. For example, in embodiments represented by FIG. 8, times-of-flight measured by either TOF measurement circuit 1844 or TOF measurement circuit 1844 may be used to detect an object in the safety range with an emission control pulse set, but only times-of-flight measured by TOF measurement circuit 844 are used to populate the 3D point cloud.

Emission control circuit 880 operates to manage accessible emission levels in a manner that allows overall operation to remain eye-safe. For example, in some embodiments, emission control circuit 880 controls whether a short-range first or second emission control pulse set or a long-range ranging pulse set is generated by setting a pulse set energy value on node 885. The emitted pulse set energy may be controlled by one or more of pulse power, pulse duration, or pulse count. Emission control circuit 880 can also control the timing of emitted pulses via the timing signal on node 857. For example, the emission control circuit can control the timing and energy of first and second emission control pulse sets and ranging pulse sets.

Emission control circuit 880 may be implemented using any suitable circuit structures. For example, in some embodiments, emission control circuit 880 may include one or more finite state machines implemented using digital logic to respond to object detection in a safety range and conditionally signal pulse generation circuit 890 to emit long-range pulse sets. Further, in some embodiments, emission control circuit 880 may include a processor and memory to provide software programmability of emission control and ranging pulse set energies, threshold values and the like. The manner in which emission control circuit 880 is implemented is not a limitation of the present invention.

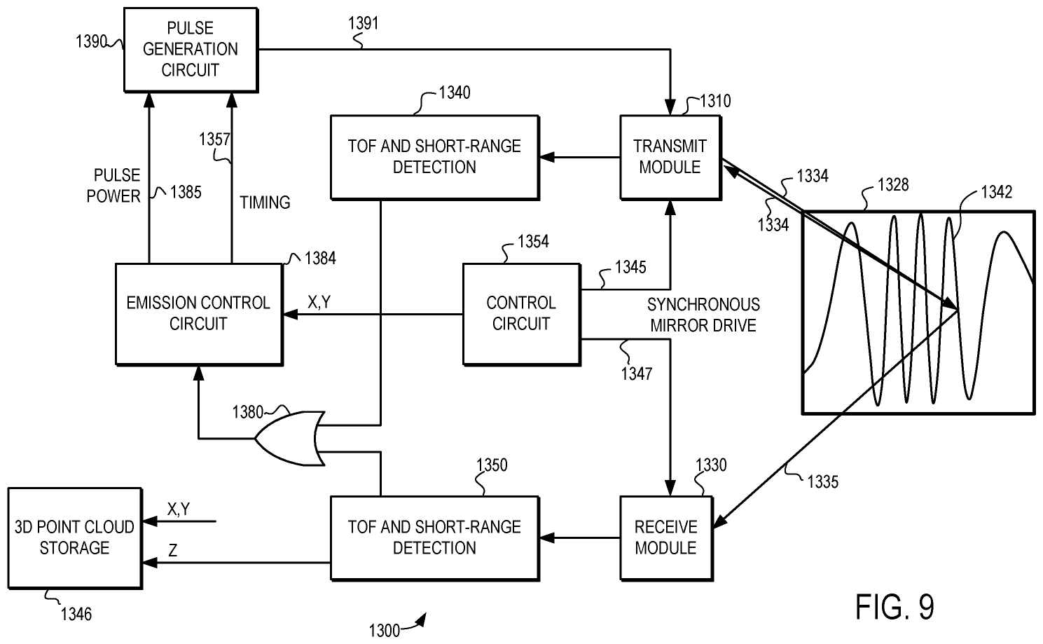

Turning now to FIG. 9, a scanning light detection and ranging (LiDAR) system 1300 in accordance with various embodiments is illustrated. LiDAR system 1300 includes emission control circuit 1384, pulse generation circuit 1390, 3D point cloud storage device 1346, OR gate 1380, and control circuit 1354. LiDAR system 1300 also includes transmit module 1310, receive module 1330, TOF and short-range detection circuits 1340, and TOF and short-range detection circuits 1350.

The LiDAR system 1300 is another example of the type of scanning laser device that can be implemented in accordance with the embodiments described herein (e.g., methods 300, 350, 360). In this example, the emission control circuit 1384, pulse generation circuit 1390 function as a light source controller, and specifically controls the transmit module 1310 to selectively emit relatively low energy first and second emission control pulse sets that are used to detect when objects (e.g., persons) are within relatively close first and second safety ranges. Then, higher energy long-range pulse sets are conditionally emitted only when objects are not detected within the first and second safety range, thus improving eye-safety.

The LiDAR system 1300 includes two separate IR detectors and TOF and short-range detection circuits for detecting reflections of IR laser pulses. Specifically, the receive module 1330 includes a first IR detector implemented to detect reflections from both short-range pulse sets (e.g., emission control pulse sets) and long-range pulse sets (e.g., ranging pules), while the transmit module 1310 includes a second IR detector that provides for the redundant detection of reflections from relatively low energy short-range emission control pulse sets to provide increased eye safety.

Transmit module 1310 includes an IR laser light source to produce a pulsed laser beam, collimating and focusing optics, and one or more scanning mirror assemblies implemented together in an optical assembly to scan the pulsed laser beam in two dimensions in the field of view. Transmit module 1310 also includes an IR laser light detector that shares an optical path with emitted IR laser light pulses. Example embodiments of transmit modules are described more fully below with reference to later figures.

Receive module 1330 includes optical devices and one or more scanning mirror assemblies to scan in two dimensions to direct reflected light from the field of view to an included IR light detector. Example embodiments of receive modules are described more fully below with reference to later figures.

Each of TOF and short-range detection circuits 1340 and 1350 include a TOF measurement circuit and comparator. For example, TOF and short-range detection circuits 1340 may include TOF circuit 1844 and second comparator 1848, and TOF and short-range detection circuits 1350 may include TOF measurement circuit 844 and comparator 848 (FIG. 8).

Control circuit 1354 controls the movement of scanning mirrors within transmit module 1310 as described above with reference to FIG. 8. Control circuit 1354 also controls the movement of scanning mirrors within receive module 1330. In operation, control circuit 1354 receives mirror position feedback information (not shown) from transmit module 1310, and also receives mirror position feedback information (not shown) from receive module 1330. The mirror position feedback information is used to phase lock the operation of the mirrors.

Control circuit 1354 drives microelectromechanical (MEMS) assemblies with scanning mirrors within transmit module 1310 with drive signal(s) 1345 and also drives MEMS assemblies with scanning mirrors within receive module 1330 with drive signal(s) 1347 that cause the mirrors to move through angular extents of mirror deflection that define the scan trajectory 1342 and the size and location of scan field 1328. The synchronization of transmit and receive scanning allows the receive aperture to only accept photons from the portion of the field of view where the transmitted energy was transmitted. This results in significant ambient light noise immunity.

The emission control circuit 1384 and pulse generation circuit 1390 control the timing and energies of the pulses emitted by transmit module 1310. For example, the pulse generation circuit 1390 can include a laser light source controller configured to vary the energy level of the laser light pulses emitted by the transmit module 1310. As such, the emission control circuit 1384 can be implemented to control the timing and energy of emitted emission control pulse sets and ranging pulse sets to implement the emission control methods 300 and 320 described above.

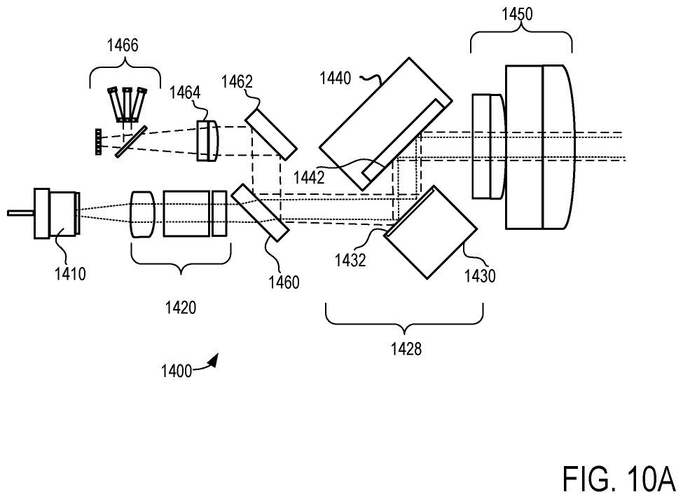

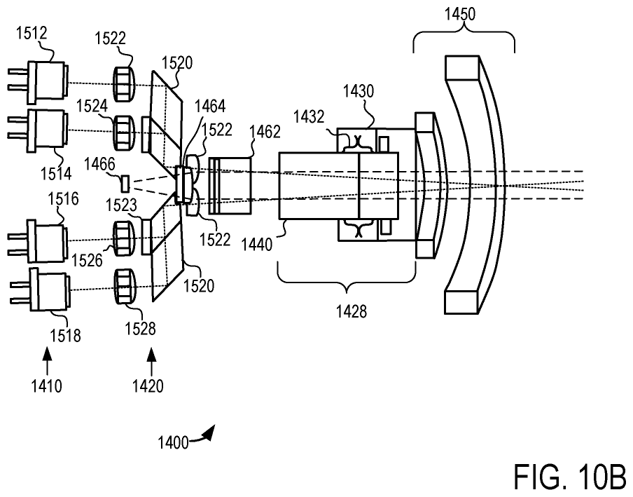

Turning now to FIGS. 10A and 10B, FIG. 10A shows a side view and FIG. 10B shows a top view of a transmit module 1400. Transmit module 1400 is an example of transmit module that can be used in a LiDAR system (e.g., transmit module 1310 of FIG. 9). Transmit module 1400 is thus another example of the type of device that can be implemented with emission control techniques described above (e.g., methods 300, 320). Transmit module 1400 includes laser light source 1410, beam shaping optical devices 1420, received energy pickoff device 1460, mirror 1462, beam shaping device 1464, IR detector 1466, scanner 1428, and exit optical devices 1450.

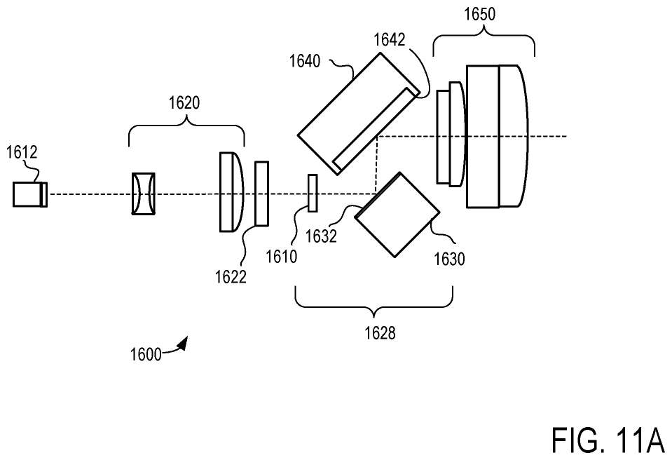

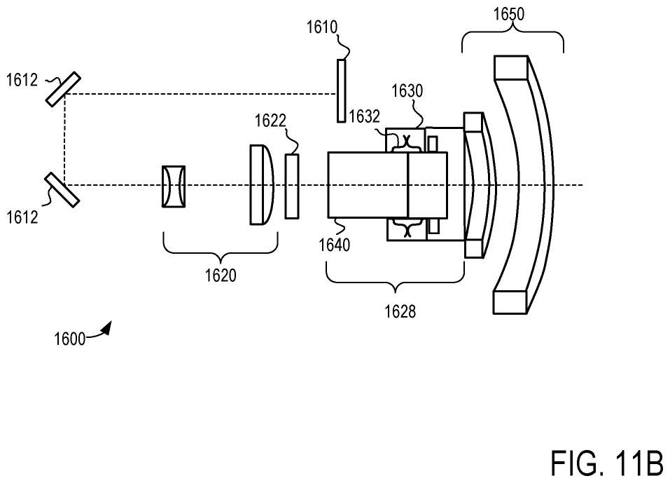

In some embodiments, laser light source 1410 sources generate nonvisible light such as infrared (IR) light. In these embodiments, IR detector 1466 detects the same wavelength of nonvisible light, as does an IR detector in receive module 1600 (FIG. 11, discussed below). For example, in some embodiments, laser light source 1410 may include a laser diode that produces infrared light with a wavelength of substantially 905 nanometers (nm), and IR detector 1466 detects reflected light pulses with a wavelength of substantially 905 nm. Also, for example, in some embodiments, laser light source 1410 may include a laser diode that produces infrared light with a wavelength of substantially 940 nanometers (nm), and IR detector 1466 detects reflected light pulses with a wavelength of substantially 940 nm. The wavelength of light is not a limitation of the present invention. Any wavelength, visible or nonvisible, may be used without departing from the scope of the present invention.

Laser light source 1410 may include any number or type of emitter suitable to produce a pulsed laser beam. For example, in some embodiments, laser light source 1410 includes multiple laser diodes shown in FIG. 10B at 1512, 1514, 1516, and 1518. The pulsed laser light produced by laser light source 1410 is combined, collimated, and focused by beam shaping optical devices 1420 to produce a pulsed laser beam. For example, optical devices 1522, 1524, 1526, 1528 may collimate the laser beams on the fast axis, polarization rotators 1523 and beam combiners 1520 may combine laser beams, and optical devices 1522 may form the pulsed laser beam into a fan on the slow axis. Beam sizes and divergence values are not necessarily uniform across the various embodiments of the present invention; some embodiments have higher values, and some embodiments have lower values.

Scanner 1428 receives the pulsed laser beam from optical devices 1420 and scans the pulsed beam in two dimensions. In embodiments represented by FIGS. 10A and 10B, scanner 1428 includes two separate scanning mirror assemblies 1430, 1440, each including a scanning mirror 1432, 1442, where each scanning mirror scans the beam in one dimension. For example, scanning mirror 1432 scans the pulsed beam in the fast scan direction, and scanning mirror 1442 scans the pulsed beam in the slow scan direction.

Although scanner 1428 is shown including two scanning mirror assemblies, where each assembly scans in a separate dimension, this is not a limitation of the present invention. For example, in some embodiments, scanner 1428 is implemented using a single biaxial scanning mirror assembly that scans in two dimensions. In some embodiments, scanning devices uses electromagnetic actuation, achieved using a miniature assembly containing a MEMS die and small subassemblies of permanent magnets and an electrical interface, although the various embodiments are not limited in this respect.

Exit optical devices 1450 operate on the scanning pulsed laser beam as it leaves the transmit module. In some embodiments, exit optical devices 1450 perform field expansion. For example, scanner 1428 may scan through maximum angular extents of 20 degrees on the fast scan axis, and may scan through maximum angular extents of 40 degrees on the slow scan axis, and exit optical devices 1450 may expand the field of view to 30 degrees on the fast scan axis and 120 degrees on the slow scan axis. The relationship between scan angles of scanning mirrors and the amount of field expansion provided by exit optical devices 1450 is not a limitation of the present invention.

Received energy pickoff device 1460 deflects received light (shown as a dotted line) that shares at least part of the transmit optical path with the emitted light pulses (shown as a solid line). The deflected received light is then reflected by mirror 1462, focused by optical device 1064, and detected by IR detector 1466. In some embodiments, pickoff device 1460 includes a “window” that transmits the pulsed beam produced by the IR laser light source, and a reflective outer portion to deflect received energy outside the window. In other embodiments, pickoff device 1460 is a partial reflector that transmits a portion of incident light and reflects the rest. For example, a reflector that transmits 90% of incident light and reflects 10% of incident light will provide the IR detector 1466 with 10% of the light reflected off an object in the field of view. In still further embodiments, pickoff device 1460 may incorporate a polarizing beam splitter that transmits the pulsed laser beam (at a first polarization), and picks off received light of a different polarization. This is effective, in part, due to the reflections being randomly polarized due to Lambertian reflection. In still further embodiments, the outgoing laser beam and received energy may be directed to different portions of the scanning mirrors, and pickoff device 1460 may be an offset mirror positioned to reflect one but not the other.

Again, to facilitate reliable detection of low energy emission control pulse sets the IR detector 1466 can be implemented with multiple sensors configured to receive reflections through at least some of the same optical assembly used to transmit laser light pulses into the scan field. Specifically, the IR detector 1466 can be configured to receive laser light pulses through the same scanning mirrors 1432, 1142, exit optical devices 1450, and other optical elements used to transmit the laser light pulses into the scan field. Because the same optical assembly is used by the multiple sensors to receive the laser light reflections any damage or blockage that prevents the multiple sensors from receiving the reflections from emission control pulse sets would also have likely blocked the scanning of the laser light pulses into the scan field. Thus, the IR detector 1466 can more reliably detect emission control pulse sets that have impacted an object in the safety range of the scan field and reflected back toward the detector, and can thus be used to reliably determine when long-range pulse sets can be emitted safely. Furthermore, the multiple sensors in the IR detector 1466 are configured to at least partially cancel the effects of back reflections from within the optical assembly. The cancellation of the effects of back reflections from within the optical assembly can improve the sensitivity of the detector, particularly for the detection of low energy emission control reflections from within the scan field.

Also as described above, the transmit module 1400 can be implemented with a laser light source controller configured to vary the energy level of the laser light pulse sets according to position along the first axis of the scan field. The variation of the energy level of the laser light pulse sets is performed provide the desired effective range of the sensor while at least partially compensating for the effects of the non-uniform optical expansion provided by the expansion optics. For example, in one embodiment the light source controller is configured to vary the energy in a manner proportional to the non-uniform variation in optical expansion. Thus, laser light pulses that are subjected to greater optical expansion are generated with greater energy levels. Additionally, the laser light source controller can be configured to vary the energy to facilitate different effective ranges in different scan regions of the scan field.

Turning now to FIGS. 11A and 11B, FIG. 11A shows a side view and FIG. 11B shows a top view of a receive module 1600. Receive module 1600 is an example of receive module that can be used in a LiDAR system (e.g., receive module 1330 of FIG. 9). Receive module 1600 is thus another example of the type of device that can be implemented with emission control techniques described above (e.g., methods 300, 350, 360). Receive module 1600 includes IR detector 1610, fold mirrors 1612, imaging optical devices 1620, bandpass filter 1622, scanner 1628, and exit optical devices 1650.

Scanning mirror assemblies 1630 and 1640 are similar or identical to scanning mirror assemblies 1430 and 1440, and exit optical devices 1650 are similar or identical to exit optical devices 1450. Bandpass filter 1422 passes the wavelength of light that is produced by laser light source 1410, and blocks ambient light of other wavelengths. For example, in some embodiments, the laser light source produces light at 905 nm, and bandpass filter 1622 passes light at 905 nm.

Imaging optical devices 1620 image a portion of the field of view onto IR detector 1610 after reflection by fold mirrors 1612. Because scanner 1628 is scanned synchronously with scanner 1428, detector 1610 always collects light from the measurement points illuminated by the scanned pulsed beam.

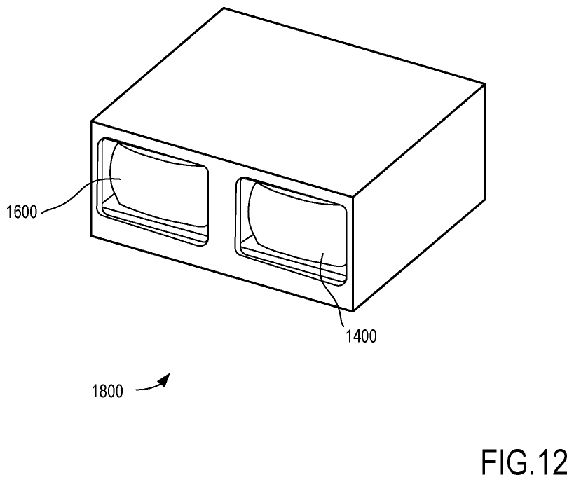

FIG. 12 shows a perspective view of an integrated photonics module in accordance with various embodiments of the present invention. Integrated photonics module 1800 includes both transmit module 1400 (FIGS. 10A and 10B) and receive module 1600 (FIGS. 11A and 11B). Integrated photonics module 1800 is shown having a rectangular housing with transmit module 1400 and receive module 1600 placed side by side. In some embodiments, transmit module 1400 and receive module 1600 are placed one on top of the other.

In the preceding detailed description, reference was made to the accompanying drawings that show, by way of illustration, specific embodiments in which the invention may be practiced. These embodiments were described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The preceding detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

Although the present invention has been described in conjunction with certain embodiments, it is to be understood that modifications and variations may be resorted to without departing from the scope of the invention as those skilled in the art readily understand. Such modifications and variations are considered to be within the scope of the invention and the appended claims.

What is claimed is:

1. An apparatus comprising:
a laser light source configured to produce laser light pulses;
an optical assembly, the optical assembly including beam scanning optics to scan the laser light pulses into a scan field;
a detector to detect reflections of the laser light pulses from measurements points in the scan field; and
a light source controller coupled to the laser light source and the detector, the light source controller adapted to control the laser light source to:
emit a first emission control pulse set at a reduced first energy level to detect objects within a first safety range;
responsive to not detecting an object within the first safety range with reflections of the first emission control pulse set, emit a second emission control pulse set following the first emission control pulse set and at a reduced second energy level to detect objects within a second safety range, where the second safety range extends further than the first safety range, and where the reduced second energy level is greater than the reduced first energy level; and
responsive to not detecting an object within the first safety range with reflections of the first emission control pulse set and to not detecting an object within the second safety range with reflections of the second emission control pulse set, emit a ranging pulse set at a higher energy level where the higher energy level is greater than the reduced first energy level and the reduced second energy level.

2. The apparatus of claim 1, wherein the first emission control pulse set, the second emission control pulse set, and the ranging pulse set area each directed to detect objects at a measurement point in a plurality of the measurement points in the scan field.

3. The apparatus of claim 1, wherein the reduced first energy level is implemented to meet a regulatory classification limit for at least all accessible portions of the first safety range, and wherein the reduced second energy level is implemented to meet the regulatory classification limit for at least a portion off the first safety range and the second safety range.

4. The apparatus of claim 1, wherein the second safety range partially overlaps with the first safety range.

5. The apparatus of claim 1, wherein the light source controller is further adapted to control the laser light source to:
responsive to detecting an object within the first safety range with reflections of the first emission control pulse set, emit at least two additional first emission control pulse sets, each at the reduced first energy level to detect objects within the first safety range before emitting a next second emission control pulse set at the reduced second energy level to detect objects within the second safety range.

6. The apparatus of claim 1, wherein the light source controller is further adapted to control the laser light source to:
responsive to detecting an object within the second safety range with reflections of the second emission control pulse set, emit at least two of a first emission control pulse set followed by the second emission control pulse set before emitting a next ranging pulse set, where the first emission control pulse sets are at the reduced first energy level to detect objects within the first safety range and second emission control pulse sets are at the reduced second energy level to detect objects within the second safety range.

7. The apparatus of claim 1, wherein the light source controller is further adapted to control the laser light source to:
responsive to detecting an object within the safety range with reflections of the first emission control pulse set, emit an adjusted first emission control pulse set, where the adjusted first emission control pulse set includes a further reduced first energy level relative.

8. The apparatus of claim 1, wherein the light source controller is further adapted to control the laser light source to:
responsive to detecting an object within the safety range with reflections of the first emission control pulse set, emit an adjusted first emission control pulse set, where the adjusted first emission control pulse set includes an extended first time period following the first emission control pulse set.

9. The apparatus of claim 1, wherein the light source controller is further adapted to control the laser light source to:
responsive to not detecting an object within the first safety range with reflections of the first emission control pulse set and to not detecting an object within the second safety range with reflections of the second emission control pulse set, emit a third emission control pulse set following the second emission control pulse set and at a reduced third energy level to detect objects within a third safety range, where the third safety range extends further than the second safety range, and where the reduced third energy level is greater than the reduced second energy level, and wherein the ranging pulse set is emitted further responsive to not detecting an object in the third safety range.

10. The apparatus of claim 1, wherein the apparatus further comprises a time-of-flight (TOF) circuitry responsive to the detector to determine distances to the measurement points in the scan field from the detected reflections.

11. The apparatus of claim 1, wherein the ranging pulse set comprises multiple pulses modulated with a signature.

12. An apparatus comprising:
a laser light source configured to produce laser light pulses;
an optical assembly, the optical assembly including beam scanning optics to scan the laser light pulses to measurement points in a scan field;
a detector to detect reflections of the laser light pulses from the measurement points in the scan field;
a time-of-flight (TOF) circuitry responsive to the detector to determine distances to the measurement points in the scan field from the detected reflections;
a light source controller coupled to the laser light source and the detector, the light source controller adapted to control the laser light source to, for each measurement point in a plurality of the measurement points:
emit a first emission control pulse set at a reduced first energy level to detect objects within a first safety range;
responsive to not detecting an object within the first safety range with reflections of the first emission control pulse set, emit a second emission control pulse set following the first emission control pulse set and at a reduced second energy level to detect objects within a second safety range, where the second safety range extends further than the first safety range, and where the reduced second energy level is greater than first energy level, otherwise proceeding to a next measurement point in the plurality of the measurement points in the scan field;
responsive to not detecting an object within the first safety range with reflections of the first emission control pulse set and to not detecting an object within the second safety range with reflections of the second emission control pulse set, emit a ranging pulse set at a higher energy level where the higher energy level is greater than the reduced first energy level and the reduced second energy level, then proceeding to the next measurement point in the plurality of the measurement points in the scan field; and
responsive to detecting an object within the first safety range with reflections of the first emission control pulse set, emit at least two additional first emission control pulse sets for a next two measurement points in the plurality of measurement points before emitting a next second emission control pulse set, each of the at least two additional first emission control pulse sets at the reduced first energy level to detect objects within the first safety range.

13. An emission control method, where the method comprises:
for each measurement point in a plurality of measurement points in a scan field:
emitting a first emission control pulse set at a reduced first energy level to detect objects within a first safety range;
responsive to not detecting an object within the first safety range with reflections of the first emission control pulse set, emitting a second emission control pulse set following the first emission control pulse set and at a reduced second energy level to detect objects within a second safety range, where the second safety range is greater than the first safety range, and where the reduced second energy level is greater than first energy level, otherwise proceeding to a next measurement point in the plurality of measurement points in the scan field; and
responsive to not detecting an object within the first safety range with reflections of the first emission control pulse set and to not detecting an object within the second safety range with reflections of the second emission control pulse set, emitting a ranging pulse set at a higher energy level where the higher energy level is greater than the reduced first energy level and the reduced second energy level, then proceeding to the next measurement point in the plurality of measurement points in the scan field.

14. The method of claim 13, wherein the reduced first energy level is implemented to meet a regulatory classification limit for at least all accessible portions of the first safety range, and wherein the reduced second energy level is implemented to meet the regulatory classification limit for at least a portion off the first safety range and the second safety range.

15. The method of claim 13, wherein the second safety range partially overlaps with the first safety range.

16. The method of claim 13, further comprising:
responsive to detecting an object within the first safety range with reflections of the first emission control pulse set, emit at least two additional first emission control pulse sets, each at the reduced first energy level to detect objects within the first safety range before emitting a next second emission control pulse set at the reduced second energy level to detect objects within the second safety range.

17. The method of claim 13, further comprising:
responsive to detecting an object within the second safety range with reflections of the second emission control pulse set, emit at least two of a first emission control pulse set followed by the second emission control pulse set before emitting a next ranging pulse set, where the first emission control pulse sets are at the reduced first energy level to detect objects within the first safety range and second emission control pulse sets are at the reduced second energy level to detect objects within the second safety range.

18. The method of claim 13, further comprising:
responsive to detecting an object within the safety range with reflections of the first emission control pulse set, emit an adjusted first emission control pulse set, where the adjusted first emission control pulse set includes a further reduced first energy level relative.

19. The method of claim 13, further comprising:
responsive to detecting an object within the safety range with reflections of the first emission control pulse set, emit an adjusted first emission control pulse set, where the adjusted first emission control pulse set includes an extended first time period following the first emission control pulse set.

20. The method of claim 13, further comprising modulating the ranging pulse set with a signature.
